(19) United States
(12) Patent Application Publication
(10) Pub. No.: US 2020/0339214 A1
(43) Pub. Date: Oct. 29, 2020

(54) SYMMETRIC BICYCLE

(71) Applicant: Ukyo Duong, San Jose, CA (US)

(72) Inventor: Ukyo Duong, San Jose, CA (US)

(21) Appl. No.: 16/859,593

(22) Filed: Apr. 27, 2020

Related U.S. Application Data
(60) Provisional application No. 62/839,387, filed on Apr. 26, 2019.

(51) Int. Cl. B62K 19/38; B62K 21/16

(52) U.S. Cl. CPC B62K 19/38; B62K 3/02; B62K 21/16

(57) ABSTRACT

Disclosed herein is a symmetric bicycle. Accordingly, the symmetric bicycle may include a bicycle frame, a bicycle handle, a plurality of bicycle wheels, and a crank assembly. Further, the bicycle frame may include a seat member, a down member, a top member, and a head member. Further, the bicycle handle may be coupled to the bicycle frame. Further, the plurality of bicycle wheels may be coupled to the bicycle frame. Further, the plurality of bicycle wheels may include at least one front bicycle wheel and at least one rear bicycle wheel. Further, the crank assembly may be coupled with at least one of the at least one front bicycle wheel and the at least one rear bicycle wheel for propelling the symmetric bicycle. Further, the crank assembly may include a crank wheel symmetrically disposed along a vertical plane passing through the seat member.

The current application claims a priority to the U.S. Provisional Patent application Ser. No. 62/839,387 filed on Apr. 26, 2019.

### FIELD OF THE INVENTION

Generally, the present disclosure relates to the field of transportation. More specifically, the present disclosure relates to a symmetric bicycle.

### BACKGROUND OF THE INVENTION

Bicycle is one of the most important creation by mankind. It is one of the means of transportation for humans of all ages. Bicycle not only serves as a transportation object but also as an exercising apparatus. Many terrains where other machine cars cannot travel, but a bicycle can still operate. Examples of such terrains are narrow mountainous roads. Since the bicycle is a convenient method of transportation for all humans, it is necessary to look for ways to improve its function and efficiency.

Therefore, there is a need for an improved symmetric bicycle that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a symmetric bicycle, in accordance with some embodiments. Accordingly, the symmetric bicycle may include a bicycle frame, a bicycle handle, a plurality of bicycle wheels, and a crank assembly. Further, the bicycle frame may include a seat member, a down member, a top member, and a head member. Further, a first top end of the top member and a first down end of the down member are coupled to the head member. Further, a second top end of the top member may be coupled to the seat member proximal to a first seat end of the seat member. Further, a second down end of the down member may be coupled to the seat member proximal to a second seat end of the seat member. Further, the seat member may include a fork disposed on the second seat end. Further, the fork may include at least one fork leg extending parallelly along a seat longitudinal axis of the seat member. Further, the bicycle handle may be coupled to the bicycle frame. Further, the plurality of bicycle wheels may be coupled to the bicycle frame. Further, the plurality of bicycle wheels may include at least one front bicycle wheel and at least one rear bicycle wheel. Further, the crank assembly may be coupled with at least one of the at least one front bicycle wheel and the at least one rear bicycle wheel for propelling the symmetric bicycle. Further, the crank assembly may include a crank wheel symmetrically disposed along a vertical plane passing through the seat member. Further, the crank wheel may include a first wheel portion disposed on a first side of the vertical plane and a second wheel portion disposed on a second side of the vertical plane. Further, the crank wheel may be rotatably coupled to a distal end of the at least one fork leg. Further, the crank wheel may be rotatable around a crank wheel axis. Further, the crank wheel axis may be perpendicular to the seat longitudinal axis. Further, the crank assembly may include at least one pedal mechanism coupled to the crank wheel. Further, the at least one pedal mechanism may be configured for receiving at least one force. Further, the receiving may be configured for rotating the crank wheel in a rotating direction.

Further disclosed herein is a symmetric bicycle, in accordance with some embodiments. Accordingly, the symmetric bicycle may include a bicycle frame, a bicycle handle, a plurality of bicycle wheels, a crank assembly, and a direction converter assembly. Further, the bicycle frame may include a seat member, a down member, a top member, and a head member. Further, a first top end of the top member and a first down end of the down member are coupled to the head member. Further, a second top end of the top member may be coupled to the seat member proximal to a first seat end of the seat member. Further, a second down end of the down member may be coupled to the seat member proximal to a second seat end of the seat member. Further, the seat member may include a fork disposed on the second seat end. Further, the fork may include at least one fork leg extending parallelly along a seat longitudinal axis of the seat member. Further, the bicycle handle may be coupled to the bicycle frame. Further, the plurality of bicycle wheels may be coupled to the bicycle frame. Further, the plurality of bicycle wheels may include at least one front bicycle wheel and at least one rear bicycle wheel. Further, the crank assembly may be coupled with at least one of the at least one front bicycle wheel and the at least one rear bicycle wheel for propelling the symmetric bicycle. Further, the crank assembly may include a crank wheel symmetrically disposed along a vertical plane passing through the seat member. Further, the crank wheel may include a first wheel portion disposed on a first side of the vertical plane and a second wheel portion disposed on a second side of the vertical plane. Further, the crank wheel may be rotatably coupled to a distal end of the at least one fork leg. Further, the crank wheel may be rotatable around a crank wheel axis. Further, the crank wheel axis may be perpendicular to the seat longitudinal axis. Further, the crank assembly may include at least one pedal mechanism coupled to the crank wheel. Further, the at least one pedal mechanism may be configured for receiving at least one force. Further, the receiving may be configured for rotating the crank wheel in a rotating direction. Further, the direction converter assembly may be disposed on the bicycle frame. Further, the rotating direction may include a first rotating direction and a second rotating direction. Further, the crank wheel may be coupled with at least one of the at least one front bicycle wheel and the at least one rear bicycle wheel using the direction converter assembly. Further, the direction converter assembly may be configured for rotating at least one of the at least one front bicycle wheel and the at least one rear bicycle wheel in the first rotating direction corresponding to the rotating of the crank wheel in each of the first rotating direction and the second rotating direction.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a bottom perspective view of a bicycle frame with a crank assembly of a symmetric bicycle, in accordance with some embodiments.

FIG. 2 is an exploded view of the crank assembly with the bicycle frame of the symmetric bicycle, in accordance with some embodiments.

FIG. 3 is a bottom perspective view of the bicycle frame of the symmetric bicycle, in accordance with some embodiments.

FIG. 4 is an exploded view of the crank assembly of the symmetric bicycle, in accordance with some embodiments.

FIG. 5 is a top view of the direction converter assembly of the symmetric bicycle, in accordance with some embodiments.

FIG. 6 is a front perspective view of the direction converter assembly of the symmetric bicycle, in accordance with some embodiments.

FIG. 7 is a perspective view of the rear wheel hub of the plurality of wheel hubs of the symmetric bicycle, in accordance with some embodiments.

FIG. 8 is an exploded view of the rear wheel hub of the plurality of wheel hubs of the symmetric bicycle, in accordance with some embodiments.

FIG. 9 is a top perspective view of a symmetric bicycle, in accordance with some embodiments.

FIG. 10 is a perspective view of the anti-rollback assembly of the symmetric bicycle, in accordance with some embodiments.

FIG. 11 is a top perspective view of the bicycle handle of the symmetric bicycle with the twist-lock mechanism, in accordance with some embodiments.

FIG. 12 is an exploded view of the twist-lock mechanism disposed in the bicycle handle, in accordance with some embodiments.

FIG. 13 is a partial perspective view of a crank assembly of the symmetric bicycle, in accordance with some embodiments.

FIG. 14 is a partial perspective view of a bicycle handle of the symmetric bicycle with a twist-lock mechanism, in accordance with some embodiments.

FIG. 15 is a bottom perspective view of a bicycle frame with a crank assembly of a symmetric bicycle, in accordance with some embodiments.

FIG. 16 is a top view of the direction converter assembly of the symmetric bicycle, in accordance with some embodiments.

FIG. 17 is a perspective view of the rear wheel hub of the plurality of wheel hubs of the symmetric bicycle, in accordance with some embodiments.

FIG. 18 is a top perspective view of a symmetric bicycle, in accordance with some embodiments.

FIG. 19 is a perspective view of the anti-rollback assembly of the symmetric bicycle, in accordance with some embodiments.

FIG. 20 is a perspective view of the twist-lock mechanism, in accordance with some embodiments.

FIG. 21 is a partial perspective view of a crank assembly of the symmetric bicycle, in accordance with some embodiments.

FIG. 22 is a front top perspective view of a first lock of the symmetric bicycle, in accordance with some embodiments.

FIG. 23 is a partial exploded view of the first lock, in accordance with some embodiments.

FIG. 24 is a side perspective of a bicycle frame of the symmetric bicycle with a second lock, in accordance with some embodiments.

FIG. 25 is a partial front perspective view of a first style of the symmetric bicycle, in accordance with some embodiments.

FIG. 26 is a partial front perspective view of a second style of the symmetric bicycle, in accordance with some embodiments.

FIG. 27 is a partial front perspective view of a third style of the symmetric bicycle, in accordance with some embodiments.

FIG. 28 is a front perspective expanded view of a fourth style of the symmetric bicycle, in accordance with some embodiments.

FIG. 29 is a front perspective collapsed view of the fourth style, in accordance with some embodiments.

FIG. 30 is a front perspective view of an anti-rollback system of the symmetric bicycle, in accordance with some embodiments.

FIG. 31 is a front perspective view of an anti-rollback system of the symmetric bicycle, in accordance with some embodiments.

FIG. 32 is a front perspective view of an anti-rollback system of the symmetric bicycle, in accordance with some embodiments.

FIG. 33 is a partial perspective view of a bicycle frame of the symmetric bicycle acting as an air tank, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a symmetric bicycle, embodiments of the present disclosure are not limited to use only in this context.

Overview:

The present disclosure describes a symmetric bicycle. Further, the present disclosure may include multiple additions to a traditional bicycle to make the bicycle more efficient. Further, the present disclosure may serve the purpose of improving a bicycle's efficiency and effectiveness while traveling.

Further, an objective of the present disclosure may be to provide a means of incorporating different mechanisms to the gear and peddling structure of the traditional bicycle. Further, the present disclosure may provide a unique way to incorporate a locking mechanism to the handle of the bicycle. Moreover, the present disclosure may include a gear mechanism that replaces the traditional gear system of a bicycle. Overall, the symmetric bicycle with infinite gears combination system is perfect for an efficient bicycle ride.

Further, the present disclosure may be a symmetric bike with infinite gears combination system. More specifically, the symmetric bike with infinite gears combination system is a device that may allow a user to use the bicycle in a more convenient and efficient way. Further, in some embodiments, the symmetric bike with infinite gears combination system may use a traditional bicycle with several components and mechanisms added to the traditional bicycle. Further, the symmetric bike with infinite gears combination system may include a first lock, a second lock, a first style, a second style, a third style, a fourth style, a fifth style, and a sixth style.

The main features of the present disclosure may include chainring/pulley ring being in the middle instead of on the right-hand side as opposed to traditional. The direction converter box where forward and/or backward pedaling propel the bike forward. The wheel hub where the tire is mounted to via spokes. The mechanism by the brake which prevents the bicycle from moving backward when activated. The twist-lock mechanism by the bicycle headset.

Further, the present disclosure may include a direction converter box. Further, the direction converter box may work as follow:

1. When the input (big pulley) rotates clockwise, a piston is pushed to one side so the small pulleys (connected by belt) are engaged and locked with big pulley while the gear is not locked.

2. When the input (big pulley) rotates counter-clockwise, the piston is pushed to the other side so the gear is engaged and locked with the big pulley while the small pulley is not locked.

3. The effect of gears connection yields equal opposite direction, while the effect of pulleys connect yields equal and same direction. Further, the direction converter box is based on this mechanic concept.

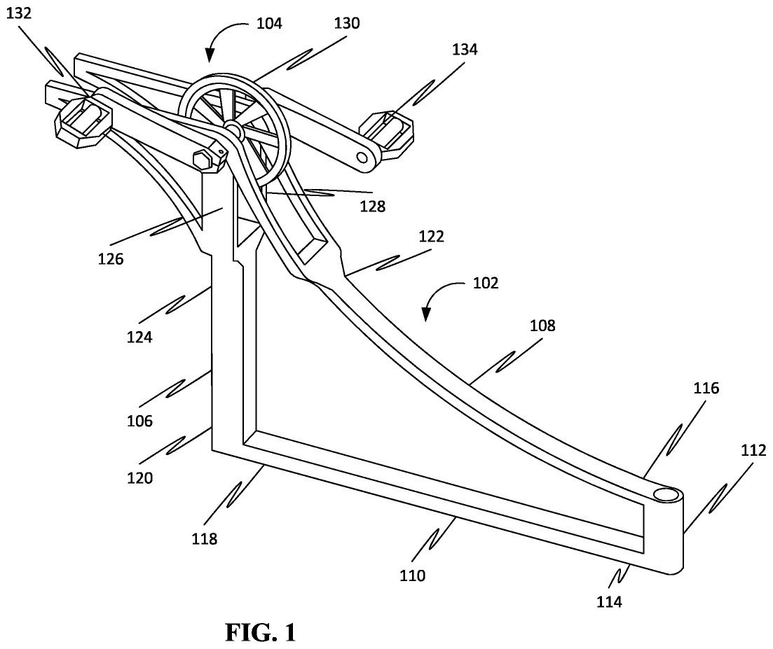

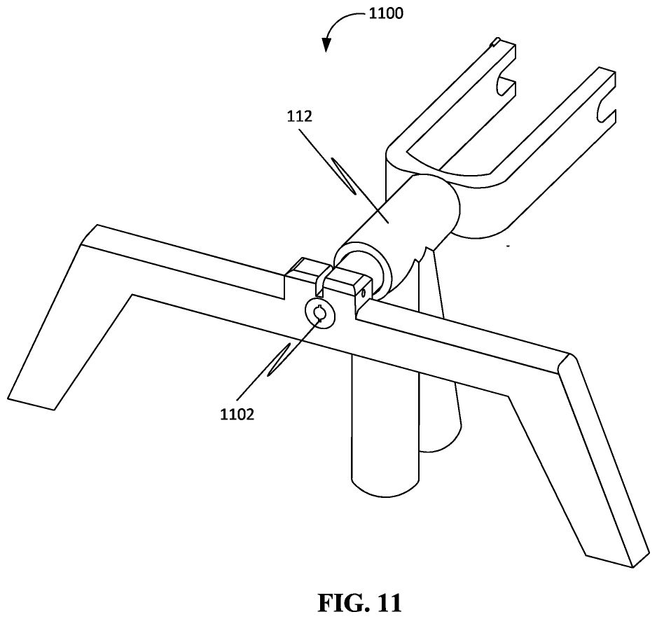

FIG. 1 is a bottom perspective view of a bicycle frame 102 with a crank assembly 104 of a symmetric bicycle, in accordance with some embodiments. Further, the symmetric bicycle may include the bicycle frame 102, a bicycle handle 1100 (as shown in FIG. 11), a plurality of bicycle wheels, and the crank assembly 104.

Further, the bicycle frame 102 may include a seat member 106, a down member 108, a top member 110, and a head member 112. Further, a first top end 114 of the top member 110 and a first down end 116 of the down member 108 are coupled to the head member 112. Further, a second top end 118 of the top member 110 may be coupled to the seat member 106 proximal to a first seat end 120 of the seat member 106. Further, a second down end 122 of the down member 108 may be coupled to the seat member 106 proximal to a second seat end 124 of the seat member 106. Further, the seat member 106 may include a fork disposed on the second seat end. Further, the fork may include at least one fork leg 126-128 extending parallelly along a seat longitudinal axis of the seat member 106.

Further, the bicycle handle 1100 may be coupled to the bicycle frame 102.

Further, the plurality of bicycle wheels may be coupled to the bicycle frame 102. Further, the plurality of bicycle wheels may include at least one front bicycle wheel 906 and at least one rear bicycle wheel 904.

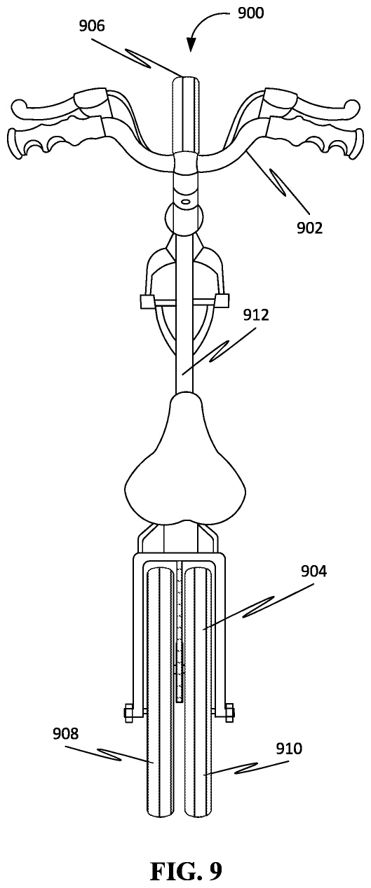

Further, the crank assembly 104 may be coupled with at least one of the at least one front bicycle wheel 906 (as shown in FIG. 9) and the at least one rear bicycle wheel 904 (as shown in FIG. 9) for propelling the symmetric bicycle. Further, the crank assembly 104 may include a crank wheel 130 symmetrically disposed along a vertical plane passing through the seat member 106. Further, the crank wheel 130 may include a first wheel portion disposed on a first side of the vertical plane and a second wheel portion disposed on a second side of the vertical plane. Further, the crank wheel 130 may be rotatably coupled to a distal end of the at least one fork leg 126-128. Further, the crank wheel 130 may be rotatable around a crank wheel axis. Further, the crank wheel axis may be perpendicular to the seat longitudinal axis. Further, the crank assembly 104 may include at least one pedal mechanism 132-134 coupled to the crank wheel 130. Further, the at least one pedal mechanism 132-134 may be configured for receiving at least one force. Further, the receiving may be configured for rotating the crank wheel 130 in a rotating direction.

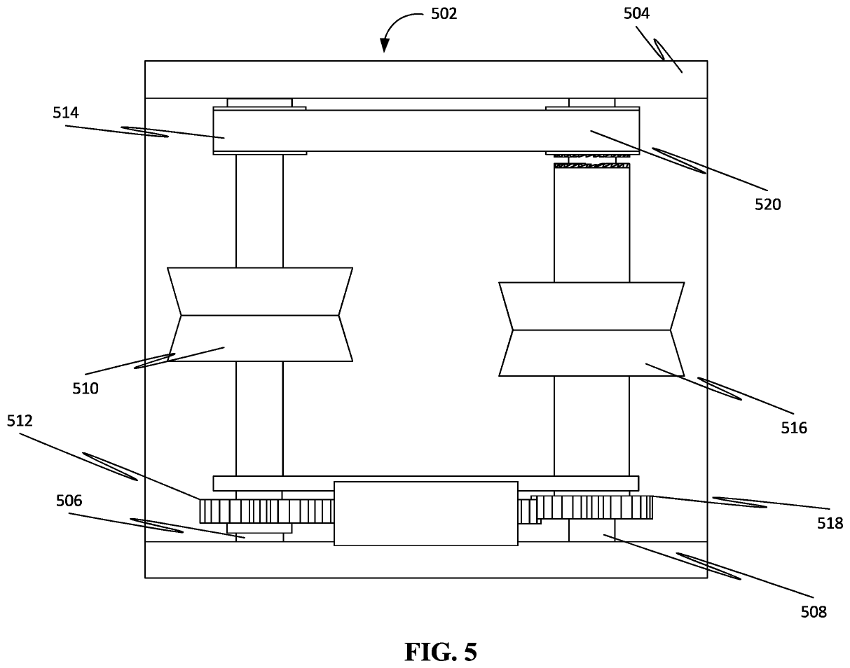

Further, in some embodiments, the symmetric bicycle may include a direction converter assembly 502, as shown in FIG. 5, disposed on the bicycle frame 102. Further, the rotating direction may include a first rotating direction and a second rotating direction. Further, the crank wheel 130 may be coupled with at least one of the at least one front bicycle wheel 906 and the at least one rear bicycle wheel 904 using the direction converter assembly 502. Further, the direction converter assembly 502 may be configured for rotating at least one of the at least one front bicycle wheel 906 and the at least one rear bicycle wheel 904 in the first rotating direction corresponding to the rotating of the crank wheel 130 in each of the first rotating direction and the second rotating direction.

Further, in an embodiment, the direction converter assembly 502 may include a converter housing 504, as shown in FIG. 5. Further, the direction converter assembly 502 may include a first rod 506 and a second rod 508. Further, the first rod 506 and the second rod 508 are parallelly disposed in the converter housing 504. Further, the first rod 506 may include a first wheel 510, a first gear 512 and a first pulley 514. Further, the first wheel 510, the first gear 512 and the first pulley 514 may be rotatable around the first rod 506. Further, the first gear 512 and the first pulley 514 may be coupled with the first wheel 510. Further, the first wheel 510 may be coupled with at least one of the at least one front bicycle wheel 906 and the at least one rear bicycle wheel 904. Further, the second rod 508 may include a second wheel 516, a second gear 518, and the second pulley 520. Further, the second wheel 516, the second gear 518, and the second pulley 520 may be rotatable around the second rod 508. Further, the second gear 518 may be coupled with the second wheel 516. Further, the second wheel 516 may be coupled with the crank wheel 130. Further, the second gear 518 may be couplable to the first gear 512. Further, the second pulley 520 may be coupled with the first pulley 514. Further, the second wheel 516 may be couplable to the second pulley 520. Further, the second rod 508 may include a lever mechanism (not shown). Further, the crank wheel 130 may be configured for rotating the second wheel 516 in the rotation direction. Further, the lever mechanism may be configured for coupling the second gear 518 to the first gear 512 based on the rotating of the second wheel 516 in the second rotating direction. Further, the second gear 518 may be configured to rotate the first gear 512 in the first rotating direction and the first wheel 510 in the first rotating direction. Further, the lever mechanism may be configured for coupling the second wheel 516 to the second pulley 520 based on the rotating of the second wheel 516 in the first rotating direction. Further, the second pulley 520 may be configured for rotating the first pulley 514 and the first wheel 510 in the first rotating direction.

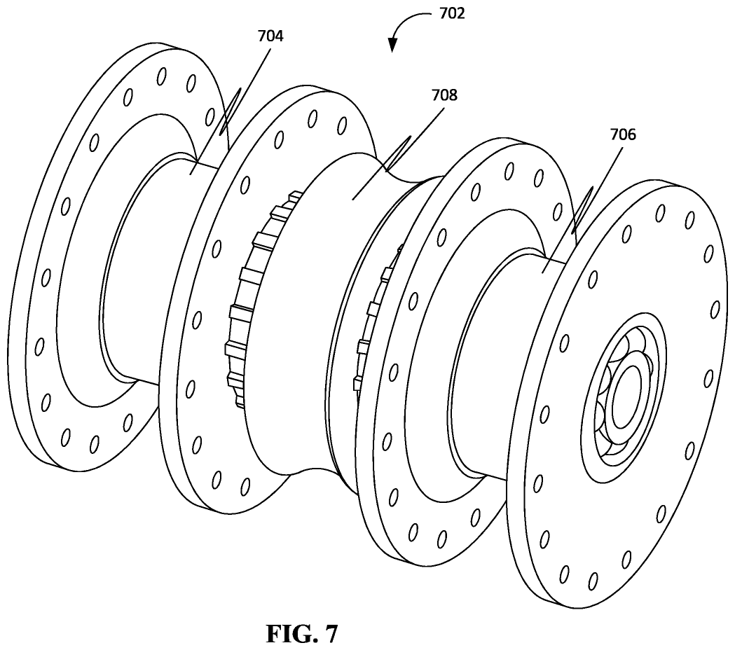

Further, in some embodiments, the plurality of bicycle wheels may include a plurality of wheel hubs. Further, a rear wheel hub 702 (as shown in FIG. 7) of the plurality of wheel hubs may include a first hub 704, a second hub 706, and a hub wheel 708, as shown in FIG. 7. Further, the first hub 704 may be axially coupled to a first side of the hub wheel 708 and the second hub 706 may be axially coupled to a second side of the hub wheel 708. Further, the at least one rear bicycle wheel 904 may include a first rear bicycle wheel 908 and a second rear bicycle wheel 910, as shown in FIG. 9. Further, the first rear bicycle wheel 908 may be coupled to the first hub 704 and the second rear bicycle wheel 910 may be coupled to the second hub 706. Further, the hub wheel 708 may be coupled with the crank wheel 130.

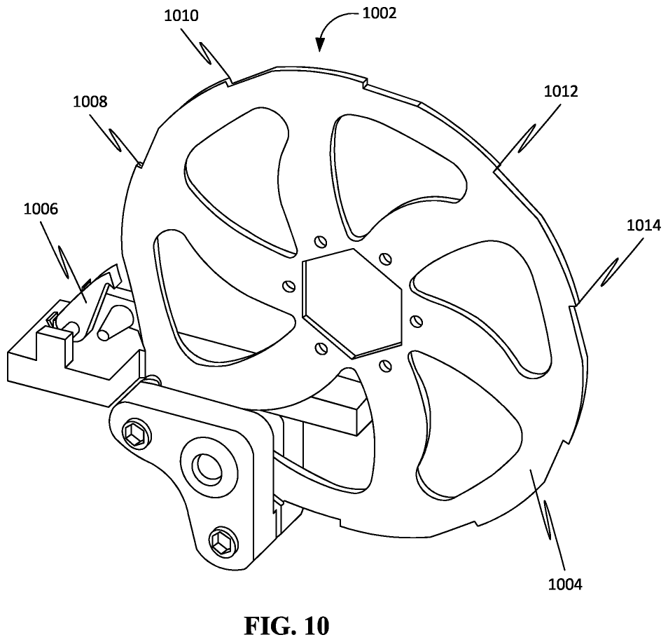

Further, in some embodiments, at least one of the at least one front bicycle wheel 906 and the at least one rear bicycle wheel 904 may include an anti-rollback assembly 1002, as shown in FIG. 10. Further, the anti-rollback assembly 1002 may include a brake disc 1004 disposed of on at least one of the at least one front bicycle wheel 906 and the at least one rear bicycle wheel 904. Further, the anti-rollback assembly 1002 may include a lever 1006 disposed on the bicycle frame 102. Further, the lever 1006 may be engageably couplable with the brake disc 1004. Further, the brake disc 1004 may include a plurality of grooves 1008-1014 disposed on the periphery of the brake disc 1004. Further, the lever 1006 may be configured for engaging with at least one groove of the plurality of grooves 1008-1014 based on a change in rotation of at least one of the at least one front bicycle wheel 906 and the at least one rear bicycle wheel 904 form a first direction to a second direction. Further, the engaging restricts subsequent rotation of at least one of the at least one front bicycle wheel 906 and the at least one rear bicycle wheel 904 in the second direction.

Further, in some embodiments, the bicycle handle 1100 may include a twist-lock mechanism 1102, as shown in FIG. 11. Further, the bicycle handle 1100 may be rotatably coupled to the head member 112. Further, the bicycle handle 1100 may be configured for rotating around a handle axis of the bicycle handle 1100 in relation to the head member 112. Further, the twist-lock mechanism 1102 may include a first lock mechanism part and a second lock mechanism part. Further, the first lock mechanism part may be disposed on the bicycle handle 1100 and the second lock mechanism part may be disposed on the head member 112. Further, the rotating of the bicycle handle 1100 to at least one handle position in relation to the head member 112 may be configured for engaging the first lock mechanism part with the second lock mechanism part. Further, the engaging restricts subsequent rotating of the bicycle handle 1100 in relation to the head member 112 from the at least one handle position.

Further, in some embodiments, the crank wheel 130 may include a plurality of protrusion disposed on a periphery of the crank wheel 130.

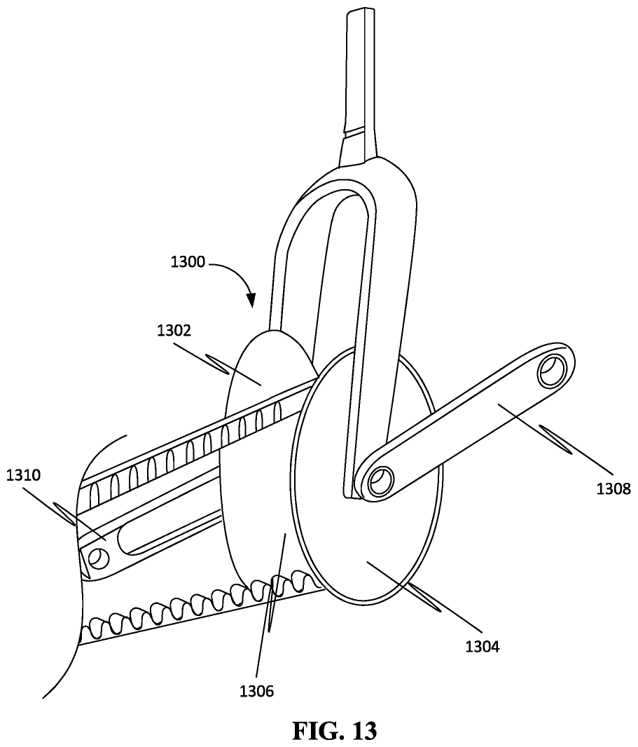

Further, in some embodiments, the first wheel portion may include a first conical portion 1302 and the second wheel portion may include a second conical portion 1304, as shown in FIG. 13. Further, the second conical portion 1304 may be retractably insertable in the first conical portion 1302 and the first conical portion 1302 may be retractably insertable in the second conical portion 1304 forming a wheel groove 1306. Further, a second apex end (not shown) of the second conical portion 1304 may be retractably insertable in a first apex end (not shown) of the first conical portion 1302 up to a second base end (not shown) of the second conical portion 1304 and the first apex end may be retractably insertable in the second apex end up to a first base end (not shown) of the first conical portion 1302. Further, the wheel groove 1306 may include an inner periphery characterized by a peripheral circumference corresponding to a conical circumference of the each of the first conical portion 1302 and the second conical portion 1304 at a length from each of the first apex end the second apex end.

Further, in some embodiments, the conical circumference progressively increases along a length of each of the first conical portion 1302 and the second conical portion 1304 from each of the first apex end and the second apex end to each of the first base end and the second base end. Further, the peripheral circumference corresponding to the conical circumference progressively increases based on inserting of the second conical portion 1304 in the first conical portion 1302 along the length from the second apex end up to the second base end and inserting of the first conical portion 1302 in the second conical portion 1304 along the length from the first apex end up to the first base end.

Further, in some embodiments, the conical circumference progressively decreases along a length of each of the first conical portion 1302 and the second conical portion 1304 from each of the first base end and the second base end to each of the first apex end and the second apex end. Further, the peripheral circumference corresponding to the conical circumference progressively decreases based on retracting of the second conical portion 1304 from the first conical portion 1302 along the length from the second base end up to the second and end and retracting of the first conical portion 1302 from the second conical portion 1304 along the length from the first base end up to the first apex end.

Further, in some embodiments, the symmetric bicycle may include a retractable inserting mechanism (not shown) coupled with the first conical portion 1302 and the second conical portion 1304. Further, the retractable inserting mechanism may include a spring-loaded piston (not shown) configured for retractably inserting the second conical portion 1304 in the first conical portion 1302 and the first conical portion 1302 in the second conical portion 1304.

Further, in some embodiments, the symmetric bicycle may include a lock assembly, coupled with at least one of the top member 110 and the seat member 106. Further, the lock assembly may be configured for securing the symmetric bicycle to at least one object (not shown). Further, the lock assembly may include an extendable cable (not shown) and a knot disposed on a first end of the cable. Further, the knot catches a second end of the cable for the securing of the symmetric bicycle.

Further, in some embodiments, the bicycle frame 102 configured for receiving at least one fluid. Further, the at least one fluid may include air. Further, the bicycle frame 102 may be configured for storing the at least one fluid. Further, at least one the seat member 106, the down member 108, the top member 110, and the head member 112 may include a cavity for the receiving and the storing of the at least one fluid. Further, the bicycle frame 102 may be configured for transferring the at least one fluid for inflating at least one tire associated with the plurality of bicycle wheels.

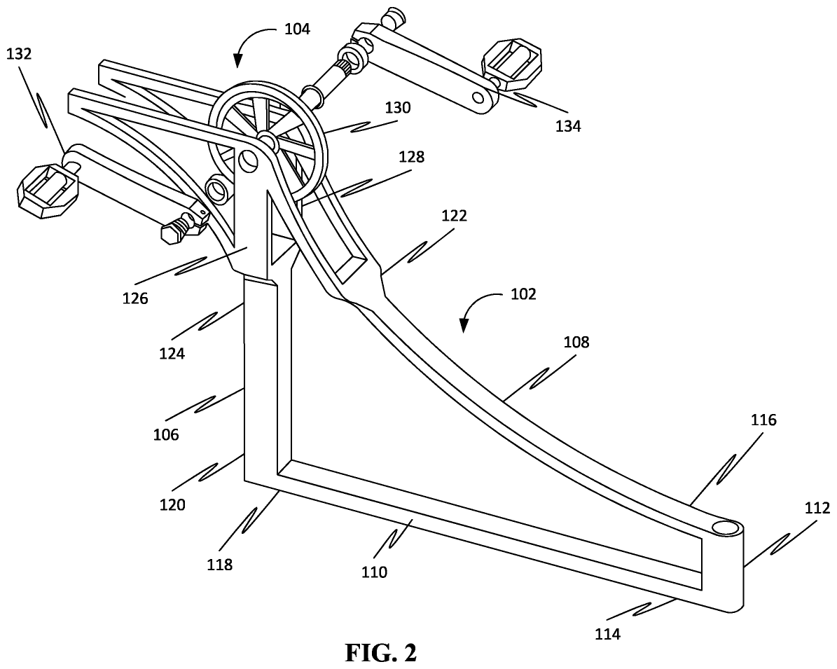

FIG. 2 is an exploded view of the crank assembly 104 with the bicycle frame 102 of the symmetric bicycle, in accordance with some embodiments.

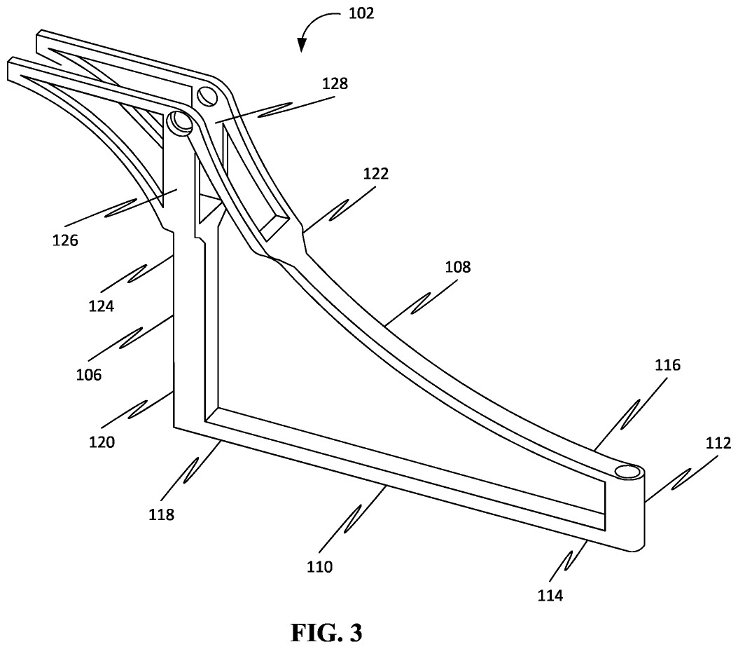

FIG. 3 is a bottom perspective view of the bicycle frame 102 of the symmetric bicycle, in accordance with some embodiments.

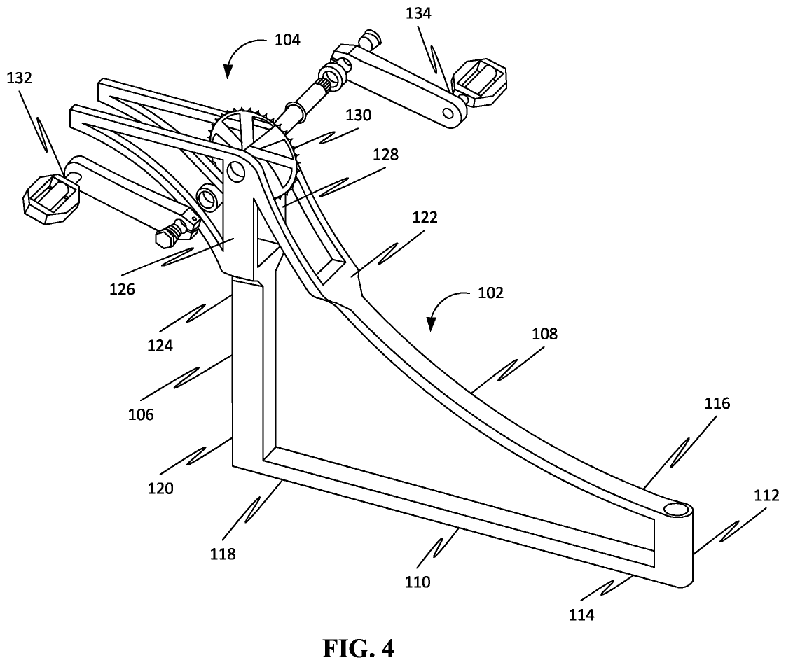

FIG. 4 is an exploded view of the crank assembly 104 of the symmetric bicycle, in accordance with some embodiments. Further, the crank assembly 104 may be coupled with at least one of the at least one front bicycle wheel 906 (as shown in FIG. 9) and the at least one rear bicycle wheel 904 (as shown in FIG. 9) for propelling the symmetric bicycle. Further, the crank assembly 104 may include the crank wheel 130 symmetrically disposed along the vertical plane passing through the seat member 106. Further, the crank assembly 104 may include at least one pedal mechanism 132-134 coupled to the crank wheel 130. Further, the at least one pedal mechanism 132-134 may be configured for receiving at least one force. Further, the receiving may be configured for rotating the crank wheel 130 in a rotating direction. Further, the crank wheel 130 may include a plurality of protrusion disposed on a periphery of the crank wheel 130.

FIG. 5 is a top view of the direction converter assembly 502 of the symmetric bicycle, in accordance with some embodiments.

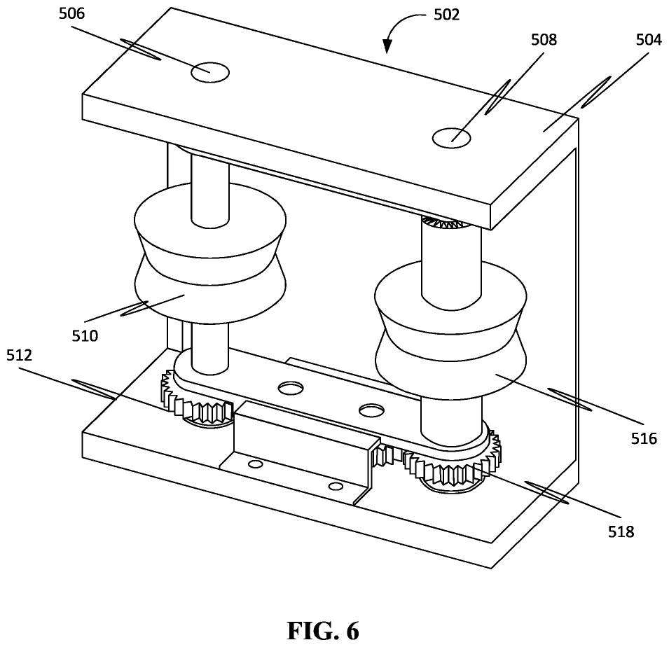

FIG. 6 is a front perspective view of the direction converter assembly 502 of the symmetric bicycle, in accordance with some embodiments.

FIG. 7 is a perspective view of the rear wheel hub 702 of the plurality of wheel hubs of the symmetric bicycle, in accordance with some embodiments.

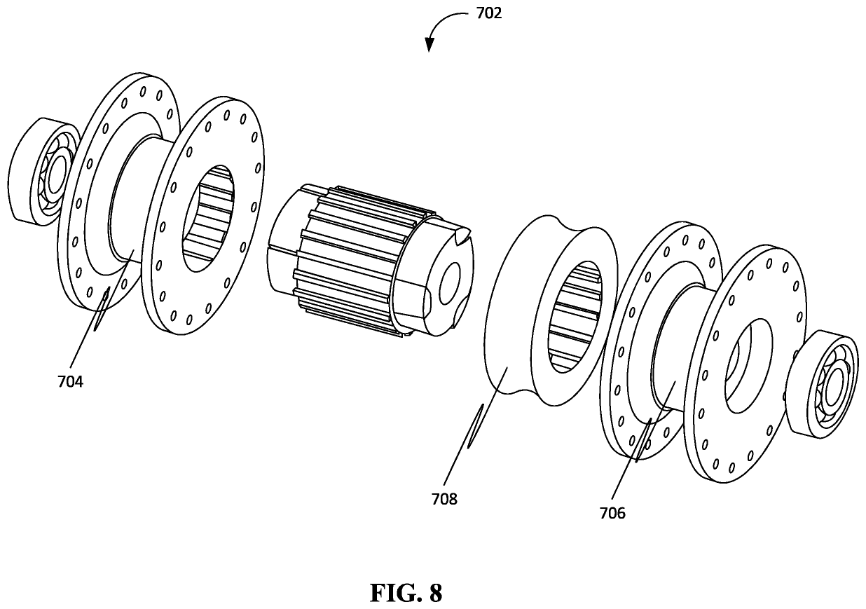

FIG. 8 is an exploded view of the rear wheel hub 702 of the plurality of wheel hubs of the symmetric bicycle, in accordance with some embodiments.

FIG. 9 is a top perspective view of a symmetric bicycle 900, in accordance with some embodiments. Further, the symmetric bicycle 900 may include a bicycle frame 912, a bicycle handle 902, a plurality of bicycle wheels, and a crank assembly. Further, the bicycle handle 902 may be coupled to the bicycle frame 912. Further, the plurality of bicycle wheels may be coupled to the bicycle frame 912. Further, the plurality of bicycle wheels may include the at least one front bicycle wheel 906 and the at least one rear bicycle wheel 904. Further, the at least one rear bicycle wheel 904 may include the first rear bicycle wheel 908 and the second rear bicycle wheel 910. Further, the crank assembly may be coupled with at least one of the at least one front bicycle wheel 906 and the at least one rear bicycle wheel 904 for propelling the symmetric bicycle.

FIG. 10 is a perspective view of the anti-rollback assembly 1002 of the symmetric bicycle, in accordance with some embodiments.

FIG. 11 is a top perspective view of the bicycle handle 1100 of the symmetric bicycle with the twist-lock mechanism 1102, in accordance with some embodiments. Further, the bicycle handle 1100 may include the twist-lock mechanism 1102. Further, the bicycle handle 1100 may be rotatably coupled to the head member 112. Further, the bicycle handle 1100 may be configured for rotating around the handle axis of the bicycle handle 1100 in relation to the head member 112. Further, the twist-lock mechanism 1102 may include the first lock mechanism part and the second lock mechanism part. Further, the first lock mechanism part may be disposed on the bicycle handle 1100 and the second lock mechanism part may be disposed on the head member 112. Further, the rotating of the bicycle handle 1100 to the at least one handle position in relation to the head member 112 may be configured for engaging the first lock mechanism part with the second lock mechanism part. Further, the engaging restricts subsequent rotating of the bicycle handle 1100 in relation to the head member 112 from the at least one handle position.

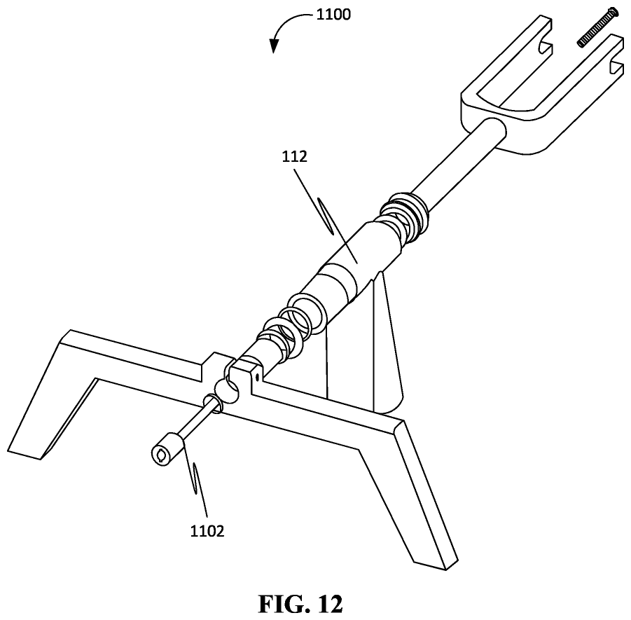

FIG. 12 is an exploded view of the twist-lock mechanism 1102 disposed in the bicycle handle 1100, in accordance with some embodiments.

FIG. 13 is a partial perspective view of a crank assembly 1300 of the symmetric bicycle, in accordance with some embodiments. Further, the crank assembly 1300 may be coupled with at least one of at least one front bicycle wheel and at least one rear bicycle wheel of the symmetric bicycle for propelling the symmetric bicycle. Further, the crank assembly 1300 may include a crank wheel symmetrically disposed along a vertical plane passing through a seat member of a bicycle frame of the symmetric bicycle. Further, the crank wheel may include a first wheel portion disposed on a first side of the vertical plane and a second wheel portion disposed on a second side of the vertical plane. Further, the crank wheel may be rotatably coupled to a distal end of the at least one fork leg. Further, the crank wheel may be rotatable around a crank wheel axis. Further, the crank wheel axis may be perpendicular to the seat longitudinal axis. Further, the crank assembly 1300 may include at least one pedal mechanism 1308-1310 coupled to the crank wheel. Further, the at least one pedal mechanism 1308-1310 may be configured for receiving at least one force. Further, the receiving may be configured for rotating the crank wheel in a rotating direction. Further, the first wheel portion may include a first conical portion 1302 and the second wheel portion may include a second conical portion 1304. Further, the second conical portion 1304 may be retractably insertable in the first conical portion 1302 and the first conical portion 1302 may be retractably insertable in the second conical portion 1304 forming a wheel groove 1306. Further, a second apex end (not shown) of the second conical portion 1304 may be retractably insertable in a first apex end (not shown) of the first conical portion 1302 up to a second base end (not shown) of the second conical portion 1304 and the first apex end may be retractably insertable in the second apex end up to a first base end (not shown) of the first conical portion 1302. Further, the wheel groove 1306 may include an inner periphery characterized by a peripheral circumference corresponding to a conical circumference of the each of the first conical portion 1302 and the second conical portion 1304 at a length from each of the first apex end the second apex end. Further, the conical circumference progressively increases along a length of each of the first conical portion 1302 and the second conical portion 1304 from each of the first apex end and the second apex end to each of the first base end and the second base end. Further, the peripheral circumference corresponding to the conical circumference progressively increases based on inserting of the second conical portion 1304 in the first conical portion 1302 along the length from the second apex end up to the second base end and inserting of the first conical portion 1302 in the second conical portion 1304 along the length from the first apex end up to the first base end. Further, the conical circumference progressively decreases along a length of each of the first conical portion 1302 and the second conical portion 1304 from each of the first base end and the second base end to each of the first apex end and the second apex end. Further, the peripheral circumference corresponding to the conical circumference progressively decreases based on retracting of the second conical portion 1304 from the first conical portion 1302 along the length from the second base end up to the second and end and retracting of the first conical portion 1302 from the second conical portion 1304 along the length from the first base end up to the first apex end.

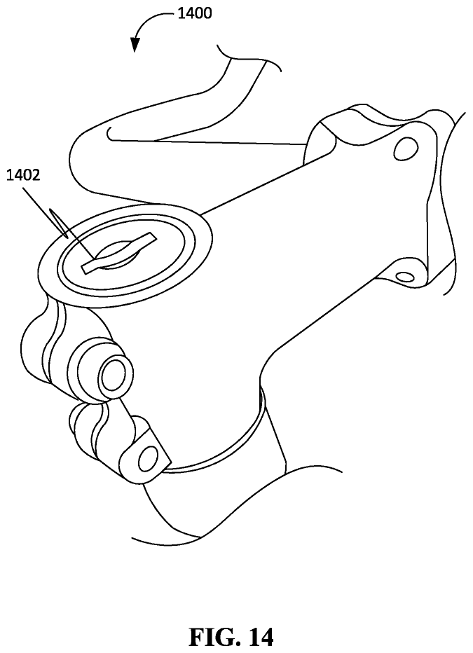

FIG. 14 is a partial perspective view of a bicycle handle 1400 of the symmetric bicycle with a twist-lock mechanism 1402, in accordance with some embodiments. Further, the bicycle handle 1400 may include the twist-lock mechanism 1402. Further, the bicycle handle 1400 may be rotatably coupled to a head member of a bicycle frame of the symmetric bicycle. Further, the bicycle handle 1400 may be configured for rotating around the handle axis of the bicycle handle 1400 in relation to the head member. Further, the twist-lock mechanism 1402 may include the first lock mechanism part and the second lock mechanism part. Further, the first lock mechanism part may be disposed on the bicycle handle 1400 and the second lock mechanism part may be disposed on the head member. Further, the rotating of the bicycle handle 1400 to the at least one handle position in relation to the head member may be configured for engaging the first lock mechanism part with the second lock mechanism part. Further, the engaging restricts subsequent rotating of the bicycle handle 1400 in relation to the head member from the at least one handle position.

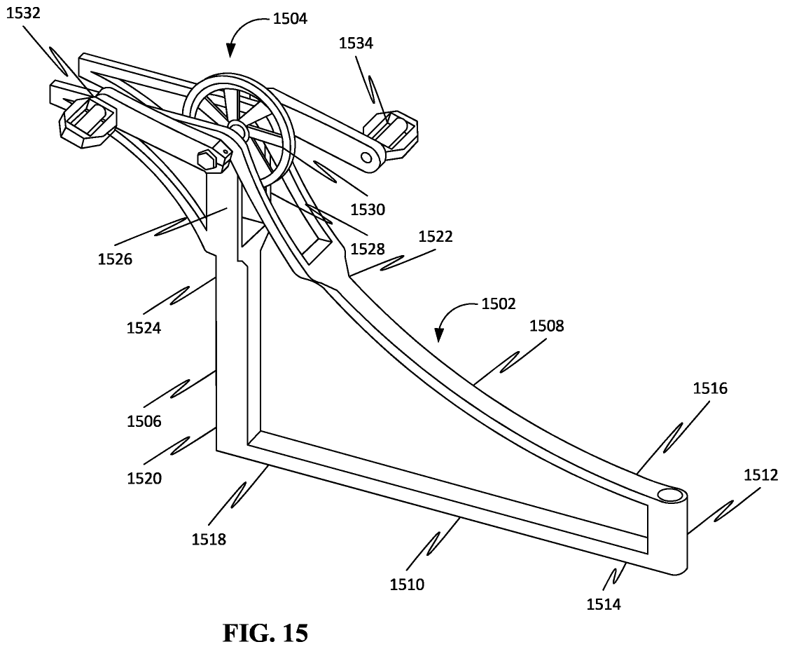

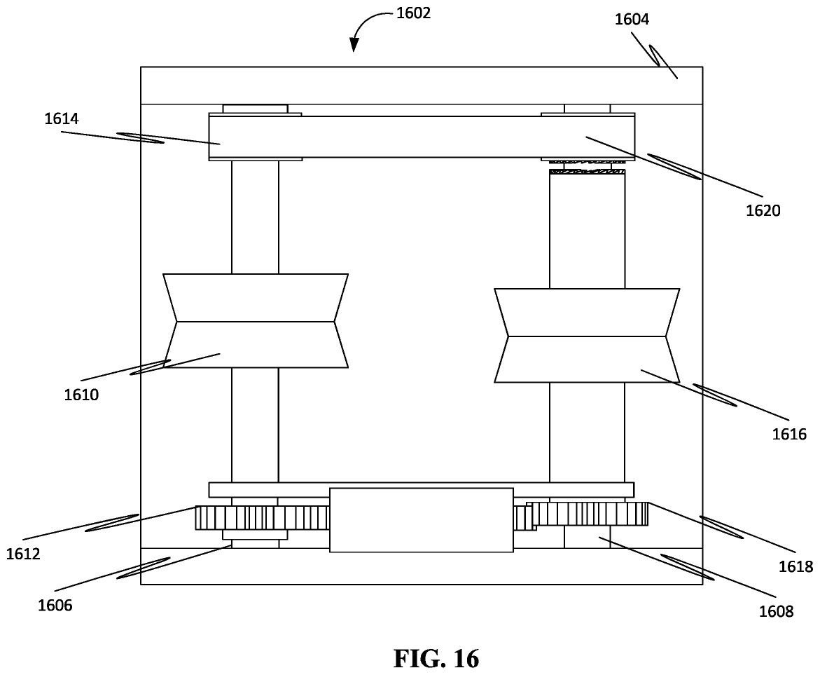

FIG. 15 is a bottom perspective view of a bicycle frame 1502 with a crank assembly 1504 of a symmetric bicycle, in accordance with some embodiments. Further, the symmetric bicycle may include the bicycle frame 1502, a bicycle handle 1802, a plurality of bicycle wheels, the crank assembly 1504, and a direction converter assembly 1602, as shown in FIG. 16.

Further, the bicycle frame 1502 may include a seat member 1506, a down member 1508, a top member 1510, and a head member 1512. Further, a first top end 1514 of the top member 1510 and a first down end 1516 of the down member 1508 are coupled to the head member 1512. Further, a second top end 1518 of the top member 1510 may be coupled to the seat member 1506 proximal to a first seat end 1520 of the seat member 1506. Further, a second down end 1522 of the down member 1508 may be coupled to the seat member 1506 proximal to a second seat end 1524 of the seat member 1506. Further, the seat member 1506 may include a fork disposed on the second seat end. Further, the fork may include at least one fork leg 1526-1528 extending parallelly along a seat longitudinal axis of the seat member 1506.

Further, the bicycle handle 1802 may be coupled to the bicycle frame 1502.

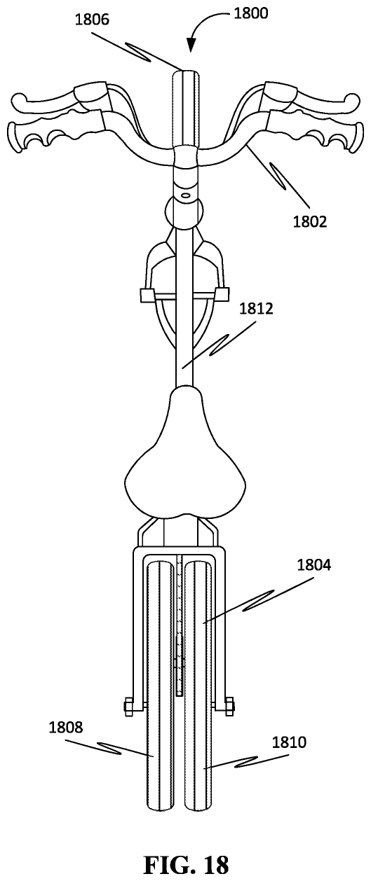

Further, the plurality of bicycle wheels may be coupled to the bicycle frame 1502. Further, the plurality of bicycle wheels may include at least one front bicycle wheel 1806 (as shown in FIG. 18) and at least one rear bicycle wheel 1804 (as shown in FIG. 18).

Further, the crank assembly 1504 may be coupled with at least one of the at least one front bicycle wheel 1806 and the at least one rear bicycle wheel 1804 for propelling the symmetric bicycle. Further, the crank assembly 1504 may include a crank wheel 1530 symmetrically disposed along a vertical plane passing through the seat member 1506. Further, the crank wheel 1530 may include a first wheel portion disposed on a first side of the vertical plane and a second wheel portion disposed on a second side of the vertical plane. Further, the crank wheel 1530 may be rotatably coupled to a distal end of the at least one fork leg 1526-1528. Further, the crank wheel 1530 may be rotatable around a crank wheel axis. Further, the crank wheel axis may be perpendicular to the seat longitudinal axis. Further, the crank assembly 1504 may include at least one pedal mechanism 1532-1534 coupled to the crank wheel 1530. Further, the at least one pedal mechanism 1532-1534 may be configured for receiving at least one force. Further, the receiving may be configured for rotating the crank wheel 1530 in a rotating direction.

Further, the direction converter assembly 1602 may be disposed on the bicycle frame 1502. Further, the rotating direction may include a first rotating direction and a second rotating direction. Further, the crank wheel 1530 may be coupled with at least one of the at least one front bicycle wheel 1806 and the at least one rear bicycle wheel 1804 using the direction converter assembly 1602. Further, the direction converter assembly 1602 may be configured for rotating at least one of the at least one front bicycle wheel 1806 and the at least one rear bicycle wheel 1804 in the first rotating direction corresponding to the rotating of the crank wheel 1530 in each of the first rotating direction and the second rotating direction. Further, in some embodiments, the direction converter assembly 1602 may include a converter housing 1604. Further, the direction converter assembly 1602 may include a first rod 1606 and a second rod 1608. Further, the first rod 1606 and the second rod 1608 are parallelly disposed in the converter housing 1604. Further, the first rod 1606 may include a first wheel 1610, a first gear 1612, and a first pulley 1614. Further, the first wheel 1610, the first gear 1612, and the first pulley 1614 may be rotatable around the first rod 1606. Further, the first gear 1612 and the first pulley 1614 may be coupled with the first wheel 1610. Further, the first wheel 1610 may be coupled with at least one of the at least one front bicycle wheel 1806 and the at least one rear bicycle wheel 1804. Further, the second rod 1608 may include a second wheel 1616, a second gear 1618, and the second pulley 1620. Further, the second wheel 1616, the second gear 1618, and the second pulley 1620 may be rotatable around the second rod 1608. Further, the second gear 1618 may be coupled with the second wheel 1616. Further, the second wheel 1616 may be coupled with the crank wheel 1530. Further, the second gear 1618 may be couplable to the first gear 1612. Further, the second pulley 1620 may be coupled with the first pulley 1614. Further, the second wheel 1616 may be couplable to the second pulley 1620. Further, the second rod 1608 may include a lever mechanism (not shown). Further, the crank wheel 1630 may be configured for rotating the second wheel 1616 in the rotation direction. Further, the lever mechanism may be configured coupling the second gear 1618 to the first gear 1612 based on the rotating of the second wheel 1616 in the second rotating direction. Further, the second gear 1618 may be configured to rotate the first gear 1612 in the first rotating direction and the first wheel 1610 in the first rotating direction. Further, the lever mechanism may be configured for coupling the second wheel 1616 to the second pulley 1620 based on the rotating of the second wheel 1616 in the first rotating direction. Further, the second pulley 1620 may be configured for rotating the first pulley 1614 in the first rotating direction and the first wheel 1610 in the first rotating direction.

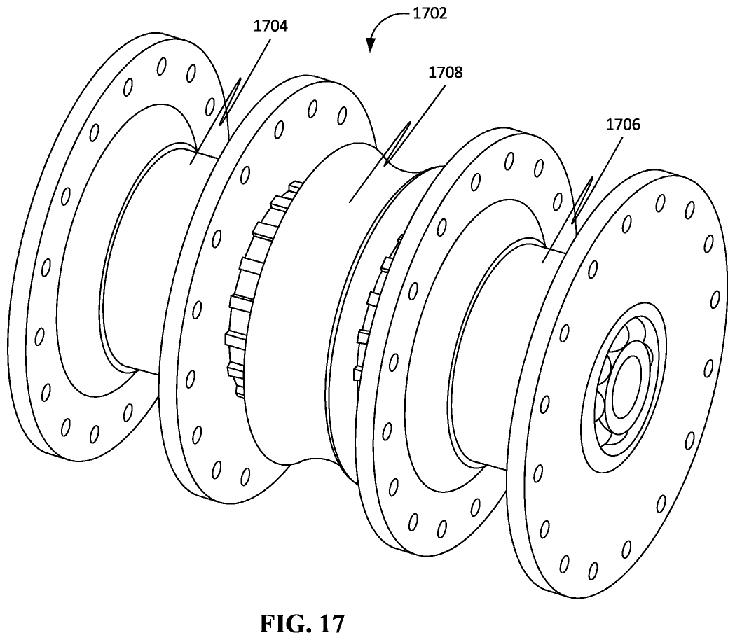

Further, in some embodiments, the plurality of bicycle wheels may include a plurality of wheel hubs. Further, a rear wheel hub 1702 of the plurality of wheel hubs may include a first hub 1704, a second hub 1706, and a hub wheel 1708, as shown in FIG. 17. Further, the first hub 1704 may be axially coupled to a first side of the hub wheel 1708 and the second hub 1706 may be axially coupled to a second side of the hub wheel 1708. Further, the at least one rear bicycle wheel may include a first rear bicycle wheel 1808 and a second rear bicycle wheel 1810, as shown in FIG. 18. Further, the first rear bicycle wheel 1808 may be coupled to the first hub 1704 and the second rear bicycle wheel 1810 may be coupled to the second hub 1706. Further, the hub wheel 1708 may be coupled with the crank wheel 1530.

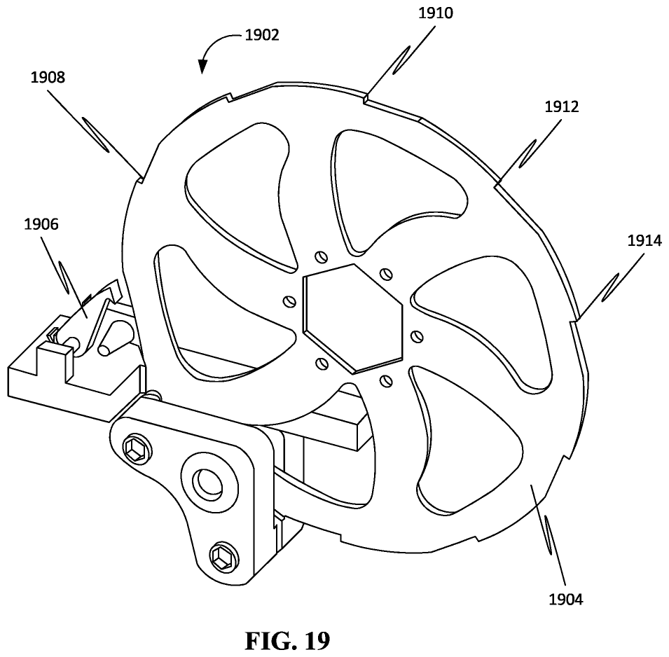

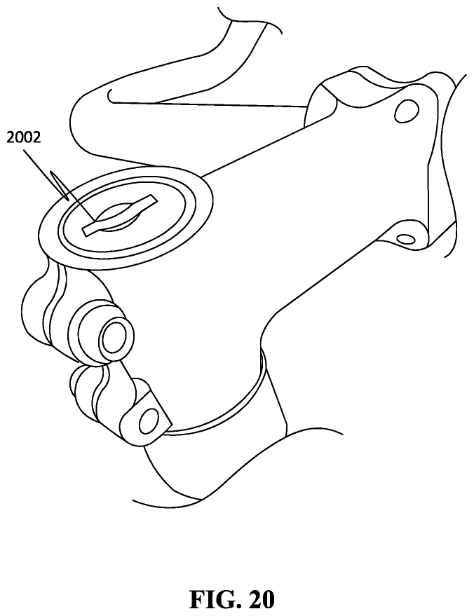

Further, in some embodiments, at least one of the at least one front bicycle wheel 1806 and the at least one rear bicycle wheel 1804 may include an anti-rollback assembly 1902, as shown in FIG. 19. Further, the anti-rollback assembly 1902 may include a brake disc 1904 disposed of on at least one of the at least one front bicycle wheel 1806 and the at least one rear bicycle wheel 1804. Further, the anti-rollback assembly 1902 may include a lever 1906 disposed on the bicycle frame 1502. Further, the lever 1906 may be engageably couplable with the brake disc 1904. Further, the brake disc 1904 may include a plurality of grooves 1908-1914 disposed on the periphery of the brake disc 1904. Further, the lever 1906 may be configured for engaging with at least one groove of the plurality of grooves 1908-1914 based on a change in rotation of at least one of the at least one front bicycle wheel 1806 and the at least one rear bicycle wheel 1804 form a first direction to a second direction. Further, the engaging restricts subsequent rotation of at least one of the at least one front bicycle wheel 1806 and the at least one rear bicycle wheel 1804 in the second direction. Further, in some embodiments, the bicycle handle 1802 may include a twist-lock mechanism 2002, as shown in FIG. 20. Further, the bicycle handle 1802 may be rotatably coupled to the head member 1512. Further, the bicycle handle 1802 may be configured for rotating around a handle axis of the bicycle handle 1802 in relation to the head member 1512. Further, the twist-lock mechanism 2002 may include a first lock mechanism part and a second lock mechanism part. Further, the first lock mechanism part may be disposed on the bicycle handle 1802 and the second lock mechanism part may be disposed on the head member 1512. Further, the rotating of the bicycle handle 1802 to at least one handle position in relation to the head member 1512 may be configured for engaging the first lock mechanism part with the second lock mechanism part. Further, the engaging restricts subsequent rotating of the bicycle handle 1802 in relation to the head member 1512 from the at least one handle position.

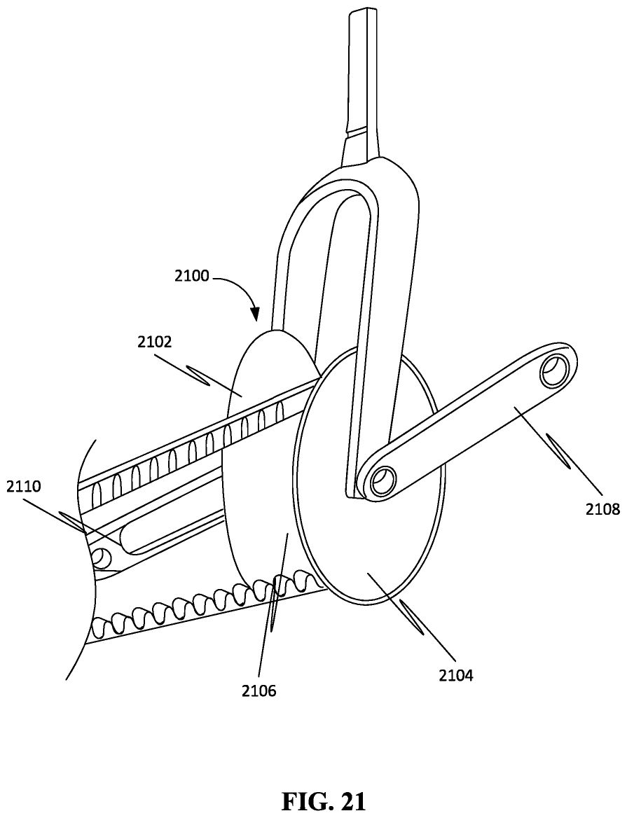

Further, in some embodiments, the first wheel portion may include a first conical portion 2102 and the second wheel portion may include a second conical portion 2104, as shown in FIG. 21. Further, the second conical portion 2104 may be retractably insertable in the first conical portion 2102 and the first conical portion 2102 may be retractably insertable in the second conical portion 2104 forming a wheel groove 2106. Further, a second apex end of the second conical portion 2104 may be retractably insertable in a first apex end of the first conical portion 2102 up to a second base end of the second conical portion 2104 and the first apex end may be retractably insertable in the second apex end up to a first base end of the first conical portion 2102. Further, the wheel groove 2106 may include an inner periphery characterized by a peripheral circumference corresponding to a conical circumference of the each of the first conical portion 2102 and the second conical portion 2104 at a length from each of the first apex end the second apex end.

Further, in some embodiments, the symmetric bicycle may include a retractable inserting mechanism (not shown) coupled with the first conical portion 2102 and the second conical portion 2104. Further, the retractable inserting mechanism may include a spring-loaded piston configured for retractably inserting the second conical portion 2104 in the first conical portion 2102 and the first conical portion 2102 in the second conical portion 2104.

FIG. 16 is a top view of the direction converter assembly 1602 of the symmetric bicycle, in accordance with some embodiments.

FIG. 17 is a perspective view of the rear wheel hub 1702 of the plurality of wheel hubs of the symmetric bicycle, in accordance with some embodiments.

FIG. 18 is a top perspective view of a symmetric bicycle 1800, in accordance with some embodiments. Further, the symmetric bicycle 1800 may include a bicycle frame 1812, the bicycle handle 1802, a plurality of bicycle wheels, a crank assembly, and a direction converter assembly. Further, the bicycle handle 1802 may be coupled to the bicycle frame 1812. Further, the plurality of bicycle wheels may be coupled to the bicycle frame 1812. Further, the plurality of bicycle wheels may include at least one front bicycle wheel 1806 and at least one rear bicycle wheel 1804. Further, the at least one rear bicycle wheel may include the first rear bicycle wheel 1808 and the second rear bicycle wheel 1810. Further, the crank assembly may be coupled with at least one of the at least one front bicycle wheel 1806 and the at least one rear bicycle wheel 1804 for propelling the symmetric bicycle 1800. Further, the direction converter assembly may be disposed on the bicycle frame 1812.

FIG. 19 is a perspective view of the anti-rollback assembly 1902 of the symmetric bicycle, in accordance with some embodiments.

FIG. 20 is a perspective view of the twist-lock mechanism 2002, in accordance with some embodiments.

FIG. 21 is a partial perspective view of a crank assembly 2100 of the symmetric bicycle, in accordance with some embodiments. Further, the crank assembly 2100 may be coupled with at least one of at least one front bicycle wheel and at least one rear bicycle wheel of the symmetric bicycle for propelling the symmetric bicycle. Further, the crank assembly 2100 may include a crank wheel symmetrically disposed along a vertical plane passing through a seat member of a bicycle frame of the symmetric bicycle. Further, the crank wheel may include a first wheel portion disposed on a first side of the vertical plane and a second wheel portion disposed on a second side of the vertical plane. Further, the crank wheel may be rotatably coupled to a distal end of the at least one fork leg. Further, the crank wheel may be rotatable around a crank wheel axis. Further, the crank wheel axis may be perpendicular to the seat longitudinal axis. Further, the crank assembly 2100 may include at least one pedal mechanism 2108-2110 coupled to the crank wheel. Further, the at least one pedal mechanism 2108-2110 may be configured for receiving at least one force. Further, the receiving may be configured for rotating the crank wheel in a rotating direction. Further, the first wheel portion may include a first conical portion 2102 and the second wheel portion may include a second conical portion 2104. Further, the second conical portion 2104 may be retractably insertable in the first conical portion 2102 and the first conical portion 2102 may be retractably insertable in the second conical portion 2104 forming a wheel groove 2106. Further, a second apex end (not shown) of the second conical portion 2104 may be retractably insertable in a first apex end (not shown) of the first conical portion 2102 up to a second base end (not shown) of the second conical portion 2104 and the first apex end may be retractably insertable in the second apex end up to a first base end (not shown) of the first conical portion 2102. Further, the wheel groove 2106 may include an inner periphery characterized by a peripheral circumference corresponding to a conical circumference of the each of the first conical portion 2102 and the second conical portion 2104 at a length from each of the first apex end the second apex end. Further, the conical circumference progressively increases along a length of each of the first conical portion 2102 and the second conical portion 2104 from each of the first apex end and the second apex end to each of the first base end and the second base end. Further, the peripheral circumference corresponding to the conical circumference progressively increases based on inserting of the second conical portion 2104 in the first conical portion 2102 along the length from the second apex end up to the second base end and inserting of the first conical portion 2102 in the second conical portion 2104 along the length from the first apex end up to the first base end. Further, the conical circumference progressively decreases along a length of each of the first conical portion 2102 and the second conical portion 2104 from each of the first base end and the second base end to each of the first apex end and the second apex end. Further, the peripheral circumference corresponding to the conical circumference progressively decreases based on retracting of the second conical portion 2104 from the first conical portion 2102 along the length from the second base end up to the second and end and retracting of the first conical portion 2102 from the second conical portion 2104 along the length from the first base end up to the first apex end.

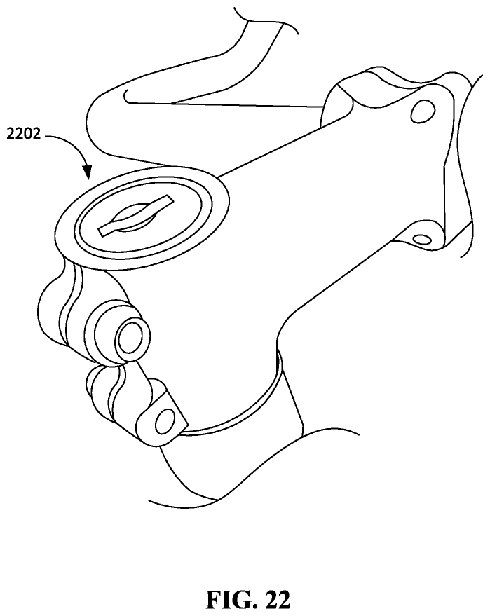

FIG. 22 is a front top perspective view of a first lock 2202 of the symmetric bicycle, in accordance with some embodiments.

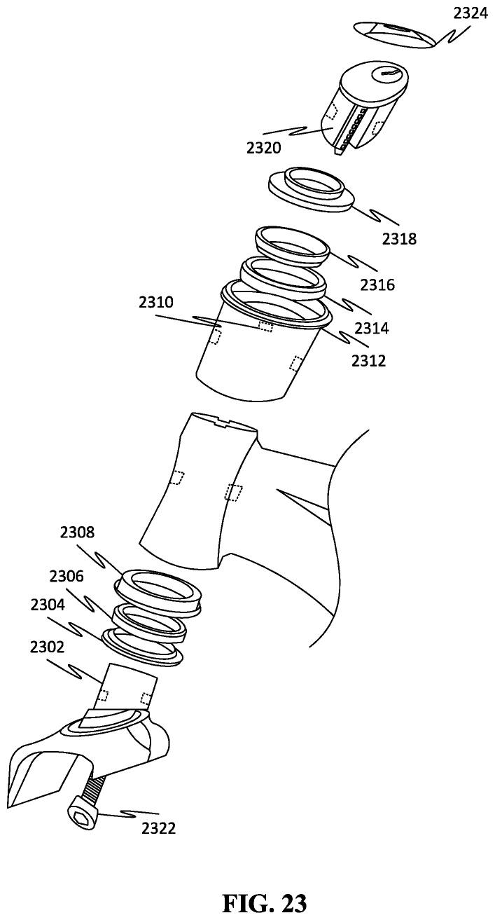

In reference to FIGS. 22-23, the first lock 2202 is a locking system of the symmetric bike with infinite gears combination system. Additionally, the first lock 2202 acts as a securing mechanism for the symmetric bike with infinite gears combination system. More specifically, the first lock 2202 may reside on the handle of a bicycle (such as the symmetric bicycle and the symmetric bicycle 900). Further, the first lock 2202 may include a fork 2302, a first aperture (not shown), a first presser 2304, a first bearing 2306, a bottom cup 2308, an externally protruded stud 2310, a plurality of grooves (not shown), a top cup 2312, a second bearing 2314, a second presser 2316, a nut 2318, a piston 2320, a threaded screw, a spring loaded piston, and a cap 2324. In reference to FIGS. 22-23, the first lock 2202 is a built-in locking system in the bicycle. Further, the fork, 2302 the first aperture, the first presser 2304, the first bearing 2306, the bottom cup 2308, the externally protruded stud 2310, the plurality of grooves, the top cup 2312, the second bearing 2314, the second presser 2316, the nut 2318, the piston 2320, the threaded screw, and the cap 2324 may reside adjacent to each other. More specifically, the first lock 2202 is a steering wheel automatic locking mechanism that locks up when the handle of the bicycle is turned at an arbitrary angle. In reference to FIGS. 22-23, the fork 2302 may include first apertures which are cut-through holes for the lock pistons to go right through to a latch onto the cut-through holes of the top cup 2312, and the incisions inside the head tube. Further, the lock may include two longitudinal female grooves that fit the two longitudinal male grooves inside a fork tube. Further, the lock bottom has a screw hole which allows a long screw to secure it from the bottom to top, from the fork tube. Further, the plurality of grooves are present so that the top cup's externally protruded studs get locked in and effectively hold the top cup 2312 in place. In reference to FIGS. 22-23, the fork 2302 may reside on the bicycle frame of the symmetric bicycle and acts as a platform for the presser (such as first presser 2304). In reference to FIGS. 22-23, the first presser 2304 is adjacent to the fork 2302 and acts as a platform for the bearing. In reference to FIGS. 22-23, the first bearing 2306 may reside on the first presser 2304 and acts as a platform for the bottom cup 2308. In reference to FIGS. 22-23, the head tube of the bicycle may reside on the bottom cup 2308, fork 2302, and an incision hole on the head tube. Further, the spring-loaded piston pushing outward all the time unless a key is inserted and turned to retract pistons momentarily. When the key is withdrawn, the piston 2320 pushes out again. Further, in some embodiments, the first lock 2202 is built-inn headset keyed automatic locking mechanism. The lock is engaged when the steering wheel is turned an arbitrary angle of 90 degrees unless disabled.

FIG. 23 is a partial exploded view of the first lock 2202, in accordance with some embodiments.

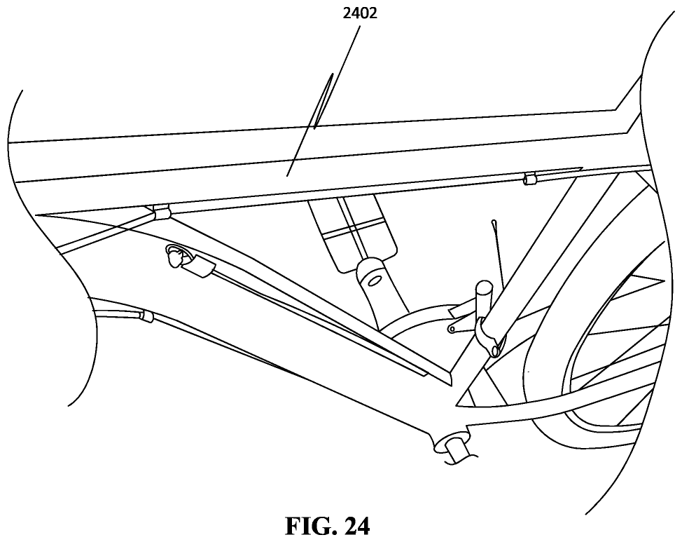

FIG. 24 is a side perspective of a bicycle frame 2402 of the symmetric bicycle with a second lock, in accordance with some embodiments. Further, the second lock is another locking system of the symmetric bike (such as the symmetric bicycle and bicycle) with infinite gears combination system. Additionally, the second lock acts as a securing mechanism for the symmetric bike with infinite gears combination system. More specifically, the second lock may reside on the seat post of the bicycle frame 2402. Further, the second lock may include a cable and a knot. In reference to FIG. 24, the second lock is a partially hidden locking mechanism. Additionally, the second lock has the cable which may reside around the perimeter of the seat post and top tube of the bicycle. More specifically, the cable may be used to lock the bicycle to any physical object so that the bicycle stays secure. Further, the second lock may be a built-in cable lock where one end of the cable is the knot. Further, the knot may remain concealed inside the bicycle body. Further, the other end of the cable protrudes and rests when not in use. Further, in some embodiments, a user may need to carry their own lock in order to lock the bicycle with an external object using the cable and the knot.

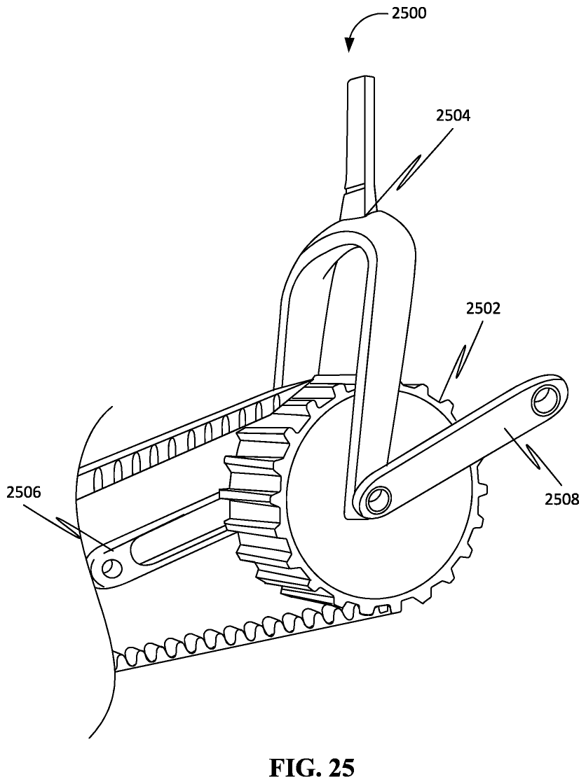

FIG. 25 is a partial front perspective view of a first style 2500 of the symmetric bicycle, in accordance with some embodiments. Further, the first style 2500 may reside on the bottom bracket of a bicycle (such as the symmetric bicycle). Further, the first style 2500 may include a first crank gear 2502, a first fork 2504, and a plurality of first pedals 2306-2308. Further, the first crank gear 2502 may reside on the bottom bracket. Additionally, the first crank gear 2502 serves as a platform for the first fork 2504 and the plurality of first pedals 2306-2308 of the first style 2500. More specifically, the first crank gear 2502 may serve as a platform for the bicycle chain. Further, the first fork 2504 is a Y-shaped structure that may reside over the first crank gear 2502. Additionally, the one end of the first fork 2504 may reside on one side of the first crank gear 2502. Further, the other end of the first fork 2504 may reside on the other end of the first crank gear 2502. This may allow for the chainring to move to the middle of the bicycle. Further, the plurality of first pedals 2306-2308 may reside on top of the fork. Moreover, one end of the plurality of first pedals 2306-2308 may reside on side of the first fork 2504 and vice versa.

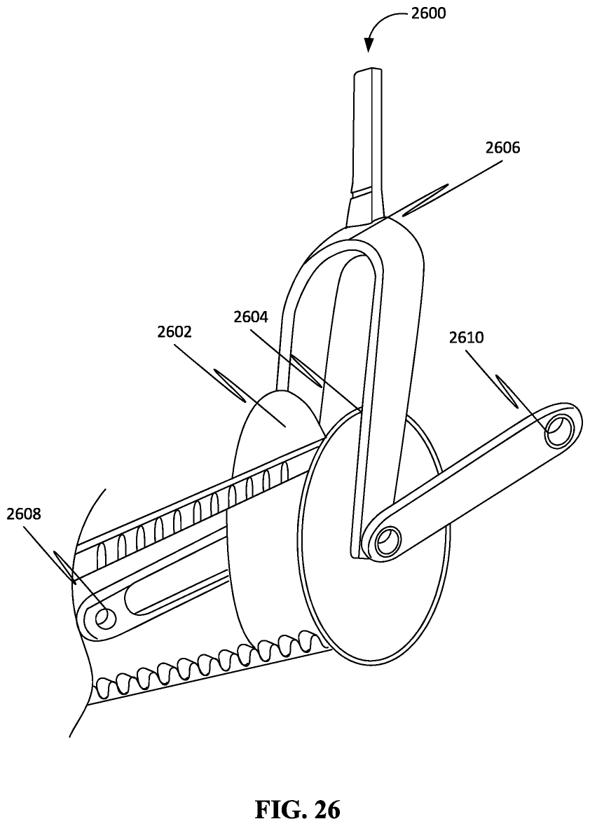

FIG. 26 is a partial front perspective view of a second style 2600 of the symmetric bicycle, in accordance with some embodiments. Further, the second style 2600 may reside on the bottom bracket of the bicycle (such as the symmetric bicycle). Further, the second style 2600 may include a first cone 2602, a second cone 2604, a second fork 2606, and a plurality of second pedals 2608-2610. Further, the first cone 2602 may reside on the bottom bracket of the bicycle. Additionally, the tapered end of the cone faces the bottom bracket of the bicycle. Further, the second cone 2604 may be placed on the surface of the bottom bracket. Similar to the first cone 2602, the tapered end of the second cone 2604 faces the bicycle surface. Further, the first cone 2602 and the second cone 2604 moves into each other. The middle area of the cone has a smaller diameter than the outer diameter. As the two cones move inward the inward diameter increases and vice versa. The middle area of the cones may serve as a platform for the chain of the bicycle. As the inward diameter of the cone increases, the gear increase which changes the gear ratio. Further, the second fork 2606 may reside on top of the first cone 2602 and the second cone 2604. Furthermore, one end of second fork 2606 is placed on the first cone 2602 while the other end of the fork is placed on the second cone 2604. Further, the plurality of second pedals 2608-2610 may reside on top of the second fork 2606. Moreover, one end of the plurality of second pedals 2608-2610 may reside on one side of the second fork 2606 and vice versa. Further, in some embodiments, the spring-loaded piston allows the first cone 2602 and the second cone 2604 to move inward and outward. Further, in some embodiments, the first cone 2602 and the second cone 2604 move into each other's grooves symmetrically.

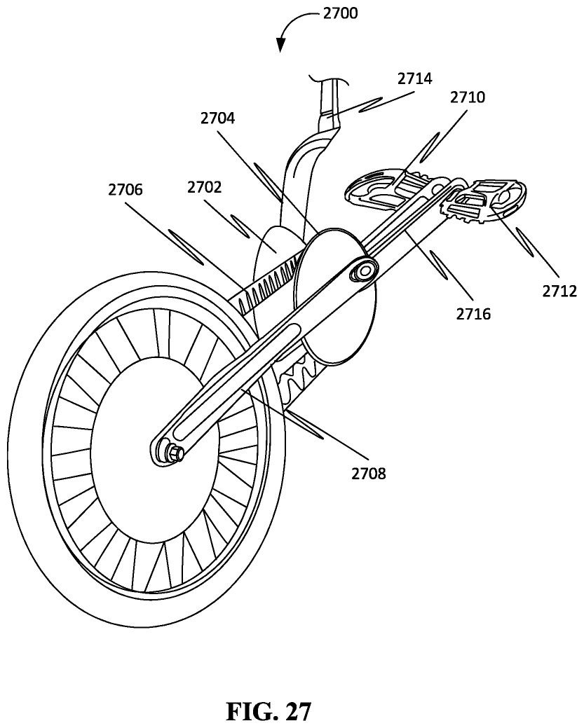

FIG. 27 is a partial front perspective view of a third style 2700 of the symmetric bicycle, in accordance with some embodiments. Further, the third style 2700 may reside on the bottom bracket of the bicycle (such as the symmetric bicycle). Further, the third style 2700 may include a third cone 2702, a fourth cone 2704, a chain 2706, a wheel rod 2708, an off-centered pivot (not shown), a pedal crank 2716, a plurality of third pedals 2710-2712, and a half fork 2714. Further, the third cone 2702 may reside on the bottom bracket of the bicycle. Additionally, the tapered end of the third cone 2702 faces the bottom bracket of the bicycle. Further, the fourth cone 2704 is placed on the surface of the bottom bracket. Similar to the third cone 2702, the tapered end of the fourth cone 2704 faces the bicycle surface. The third cone 2702 and the fourth cone 2704 moves into each other. The middle area of the cone has a smaller diameter than the outer diameter. As the two cones move inward the inward diameter increases and vice versa. The middle area of the cones serves as a platform for the chain 2706 of the bicycle. Further, the chain 2706 of the bicycle may reside on the junction of the third cone 2702 and the fourth cone 2704. The chain 2706 extends from the cone to the wheels. Further, the wheel rod 2708 extends from the third cone 2702 and the fourth cone 2704 to the middle of the wheel. The wheel rod 2708 has an off-centered pivot where one end of the wheel rod 2708 doesn't reside on the center of the cone. Further, the pedal crank 2716 is adjacent to the wheel rod 2708. Additionally, the pedal crank 2716 extends from the off-centered pivot to the plurality of third pedals 2710-2712. Further, the plurality of third pedals 2710-2712 is adjacent to the pedal crank 2716. Additionally, the plurality of third pedals 2710-2712 serves as a platform for the user's feet. Further, the half fork 2714 may reside adjacent to the off-centered pivot. Moreover, the half fork 2714 extends from the off-centered pivot to the down tube of the bicycle. More specifically, the plurality of third pedals 2710-2712 are in the same direction but at the opposite side of cones unlike the traditional bicycle. Moreover, the plurality of third pedals 2710-2712 are anchored off-centered. The half fork 2714 is used to connect the third style 2700 to the bicycle frame. The wheels and the third cone 2702 and the fourth cone 2704 are connected via the wheel rod 2708. Therefore, when the plurality of third pedals 2710-2712 bottom out, the moment of inertia causes pedals to continue in their course of rotating and returning to the top.

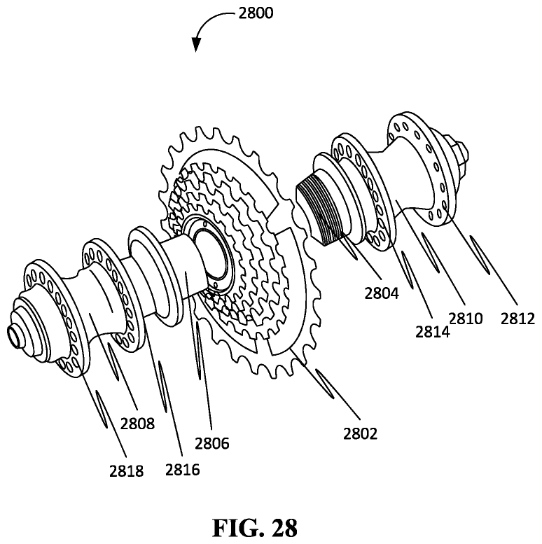

FIG. 28 is a front perspective expanded view of a fourth style 2800 of the symmetric bicycle, in accordance with some embodiments.

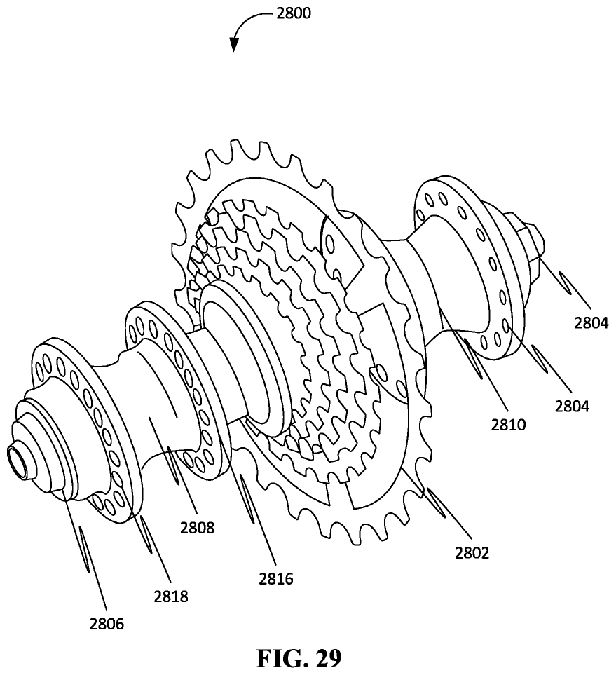

FIG. 29 is a front perspective collapsed view of the fourth style 2800, in accordance with some embodiments.

In reference to FIGS. 28-29, the fourth style 2800 may reside on the center of the back wheels of the bicycle. Further, the fourth style 2800 may include the rear wheel hub (such as 702 and the rear wheel hub 1702). Further, the fourth style 2800 may include a cassette 2802, an infinite gear (not shown), a male connector 2804, a female connector 2806, a first hub 2808, a second hub 2810, and a plurality of flanges 2812-2818. Further, the fourth style 2800 is a rear hub double single unit. Additionally, the fourth style 2800 is different than a traditional bicycle in a way where the gears are sandwiched by a plurality of hubs by threaded screw into each other. Further, the cassette 2802 may reside on the center of the rear wheel of the bicycle (such as the symmetric bicycle). Moreover, the cassette 2802 serves as a platform for the infinite gear. Further, the cassette may include the hub wheel (such as the hub wheel 708 and the hub wheel 1708). Further, the infinite gear is the platform for the chain of the bicycle. Further, the male connector 2804 may reside on one side of the cassette 2802. Additionally, the male connector 2804 fits into the center hole of the cassette 2802. Further, the female connector 2806 is positioned opposite to the male connector 2804. More specifically, the female connector 2806 fits through the center hole of the cassette 2802 and joins the male connector 2804 of the fourth style 2800. Further, the first hub 2808 is adjacent to the male connector 2804 of the fourth style 2800. The first hub 2808 has two flanges on either side. Moreover, the first hub 2808 serves as a platform for the wheel (such as the plurality of bicycle wheels) to connect to. Further, the second hub 2810 is adjacent to the female connector 2806 of the fourth style 2800. Similar to the first hub 2808, the second hub 2810 also has two flanges on either side of the hub. Further, the second hub 2810 serves a platform for the second wheel.

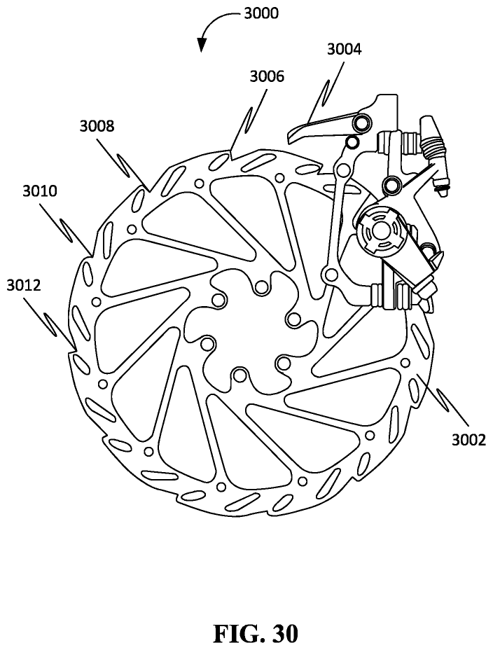

FIG. 30 is a front perspective view of an anti-rollback system 3000 of the symmetric bicycle, in accordance with some embodiments.

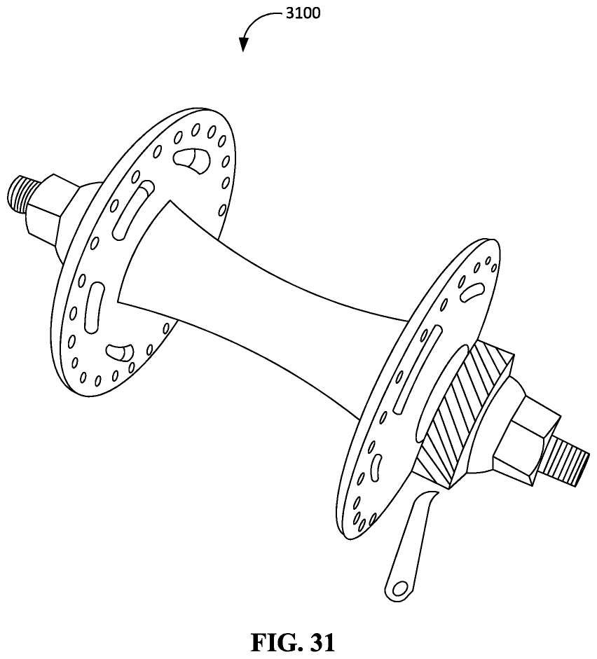

FIG. 31 is a front perspective view of an anti-rollback system 3100 of the symmetric bicycle, in accordance with some embodiments.

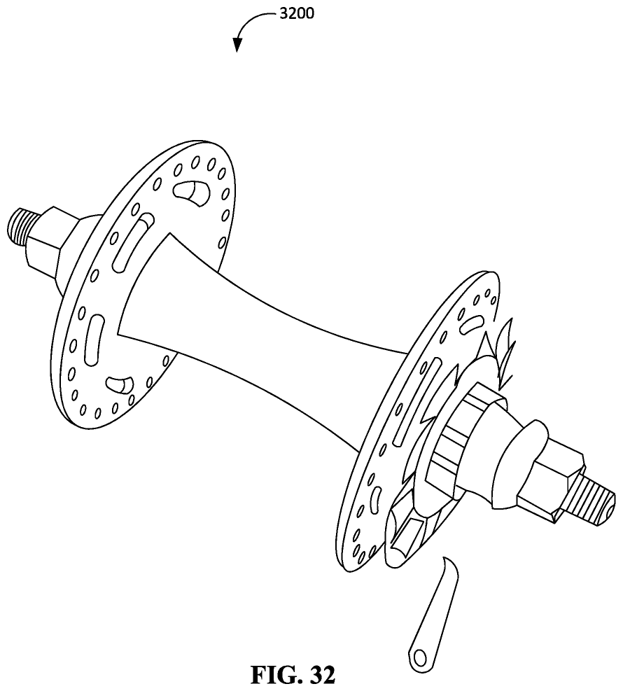

FIG. 32 is a front perspective view of an anti-rollback system 3200 of the symmetric bicycle, in accordance with some embodiments.

In reference to FIGS. 30-32, the anti-rollback system 3000 may reside on the front wheel of the bicycle. Further, the anti-rollback system 3000 may reside on at least one of the at least one front bicycle wheel and the at least one rear bicycle wheel. Further, the anti-rollback system 3000 may include a brake disc 3002, a saw level 3006-3012, a lever 3004, and a brake caliper system. In reference to FIG. 30, the brake disc 3002 may reside at the center of the front wheel. More specifically, the brake disc 3002 acts as a platform for the brake caliper system. The brake disc 3002 has saw level 3006-3012 throughout the perimeter. The saw level 3006-3012 acts as a groove for the lever 3004 to lock into. This mechanism works similar to a ratchet mechanism. When the lever 3004 is locked in the saw level 3006-3012, the wheel doesn't roll backward. Further, the brake caliper system may reside on the brake disc 3002. More specifically, the brake caliper system acts as a platform for the lever 3004. The anti-rollback system 3000 deploys at brake system where the mechanism prevents the brake disc 3002 from rotating backward. The brake disc 3002 is statically attached to the wheel, therefore, the wheel cannot roll backward. This anti-rollback system 3000 doesn't allow the wheels to go backward. Further, the anti-rollback system 3000 can be used in two different embodiments as shown in the FIG. 31 and the FIG. 32.

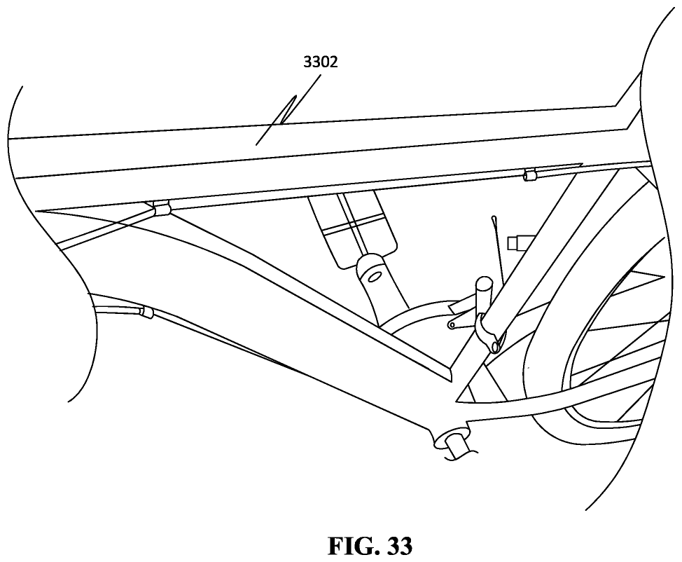

FIG. 33 is a partial perspective view of a bicycle frame 3302 of the symmetric bicycle acting as an air tank, in accordance with some embodiments. Further, the bicycle frame 3302 acts as an air tank. Further, the bicycle frame 3302 may have a valve that allows air in or not. More specifically, this acts as an air pump system for the tires when the tires are low or out of air.

Further, in some embodiments, the direction converter assembly (such as the direction converter assembly 502 and the direction converter assembly 1602) may include a forward propelling gear system housed in a box. The gear system may include a first rod and a second rod. The first rod and the second rod sit parallel to each other. The first rod may include a first gear, a second gear, and a first pulley. The components in the first rod are arranged in an adjacent manner. The first pulley is adjacent to the first and second gear. The second rod may reside parallel to the first rod. The second rod may include a third gear, a fourth gear, a second pulley, a lever arm, and an engagement locking slot. Similar to the first rod, the components of the second rod are also attached in an adjacent manner. When the lever arm slides the third gear outward, the cogs of the third gear physically contacts the cogs of the second gear. The protruded studs on the second rod no longer locked into the indented slots of the second pulley. Thus, the axle of the third gear does not affect the second pulley when spun. Similarly, when the lever arm slides the third gear inward on the z-axis such that the cogs on the third gear do not physically touch cogs of the second gear. Then the protruded studs on the axle (second rod) of the third gear sink into the grooves of the second pulley. Further, in some embodiments, the bicycle combination system has a pedaling direction which is opposite to the traditional conventional way. The pedals anti-clockwise instead of the clockwise direction. The bicycle still moves forward even with this mechanism. More specifically, the chainring is connected to transmission which in turn is connected to the rear portion of the bicycle. This detects the motion of going forward and backward.

Although the present disclosure has been explained in relation to its preferred embodiment, it is to be understood that many other possible modifications and variations can be made without departing from the spirit and scope of the disclosure.

The following is claimed:

1. A symmetric bicycle comprising:
a bicycle frame comprising a seat member, a down member, a top member, and a head member, wherein a first top end of the top member and a first down end of the down member are coupled to the head member, wherein a second top end of the top member is coupled to the seat member proximal to a first seat end of the seat member, wherein a second down end of the down member is coupled to the seat member proximal to a second seat end of the seat member, wherein the seat member comprises a fork disposed on the second seat end, wherein the fork comprises at least one fork leg extending parallelly along a seat longitudinal axis of the seat member;
a bicycle handle coupled to the bicycle frame;
a plurality of bicycle wheels coupled to the bicycle frame, wherein the plurality of bicycle wheels comprises at least one front bicycle wheel and at least one rear bicycle wheel; and
a crank assembly coupled with at least one of the at least one front bicycle wheel and the at least one rear bicycle wheel for propelling the symmetric bicycle, wherein the crank assembly comprises a crank wheel symmetrically disposed along a vertical plane passing through the seat member, wherein the crank wheel comprises a first wheel portion disposed on a first side of the vertical plane and a second wheel portion disposed on a second side of the vertical plane, wherein the crank wheel is rotatably coupled to a distal end of the at least one fork leg, wherein the crank wheel is rotatable around a crank wheel axis, wherein the crank wheel axis is perpendicular to the seat longitudinal axis, wherein the crank assembly comprises at least one pedal mechanism coupled to the crank wheel, wherein the at least one pedal mechanism is configured for receiving at least one force, wherein the receiving is configured for rotating the crank wheel in a rotating direction.

2. The symmetric bicycle of claim 1 further comprising a direction converter assembly disposed on the bicycle frame, wherein the rotating direction comprises a first rotating direction and a second rotating direction, wherein the crank wheel is coupled with at least one of the at least one front bicycle wheel and the at least one rear bicycle wheel using the direction converter assembly, wherein the direction converter assembly is configured for rotating at least one of the at least one front bicycle wheel and the at least one rear bicycle wheel in the first rotating direction corresponding to the rotating of the crank wheel in each of the first rotating direction and the second rotating direction.

3. The symmetric bicycle of claim 2, wherein the direction converter assembly comprises a converter housing, wherein the direction converter assembly comprises a first rod and a second rod, wherein the first rod and the second rod are parallelly disposed in the converter housing, wherein the first rod comprises a first wheel, a first gear and a first pulley, wherein the first wheel, the first gear, and the first pulley is rotatable around the first rod, wherein the first gear and the first pulley is coupled with the first wheel, wherein the first wheel is coupled with at least one of the at least one front bicycle wheel and the at least one rear bicycle wheel, wherein the second rod comprises a second wheel a second gear, and the second pulley, wherein the second wheel, the second gear and the second pulley is rotatable around the second rod, wherein the second gear is coupled with the second wheel, wherein the second wheel is coupled with the crank wheel, wherein the second gear is couplable to the first gear, wherein the second pulley is coupled with the first pulley, wherein the second wheel is couplable to the second pulley, wherein the second rod comprises a lever mechanism, wherein the crank wheel is configured for rotating the second wheel in the rotation direction, wherein the lever mechanism is configured for coupling the second gear to the first gear based on the rotating of the second wheel in the second rotating direction, wherein the second gear is configured to rotate the first gear in the first rotating direction and the first wheel in the first rotating direction, wherein the lever mechanism is configured for coupling the second wheel to the second pulley based on the rotating of the second wheel in the first rotating direction, wherein the second pulley is configured for rotating the first pulley in the first rotating direction and the first wheel in the first rotating direction.

4. The symmetric bicycle of claim 1, wherein the plurality of bicycle wheels comprises a plurality of wheel hubs, wherein a rear wheel hub of the plurality of wheel hubs comprises a first hub, a second hub, and a hub wheel, wherein the first hub is axially coupled to a first side of the hub wheel and the second hub is axially coupled to a second side of the hub wheel, wherein the at least one rear bicycle wheel comprises a first rear bicycle wheel and a second rear bicycle wheel, wherein the first rear bicycle wheel is coupled to the first hub and the second rear bicycle wheel is coupled to the second hub, wherein the hub wheel is coupled with the crank wheel.

5. The symmetric bicycle of claim 1, wherein at least one of the at least one front bicycle wheel and the at least one rear bicycle wheel comprises an anti-rollback assembly, wherein the anti-rollback assembly comprises a brake disc disposed of on at least one of the at least one front bicycle wheel and the at least one rear bicycle wheel, wherein the anti-rollback assembly comprises a lever disposed on the bicycle frame, wherein the lever is engageably couplable with the brake disc, wherein the brake disc comprises a plurality of grooves disposed on the periphery of the brake disc, wherein the lever is configured for engaging with at least one groove of the plurality of grooves based on a change in rotation of at least one of the at least one front bicycle wheel and the at least one rear bicycle wheel form a first direction to a second direction, wherein the engaging restricts subsequent rotation of at least one of the at least one front bicycle wheel and the at least one rear bicycle wheel in the second direction.

6. The symmetric bicycle of claim 1, wherein the bicycle handle comprises a twist-lock mechanism, wherein the bicycle handle is rotatably coupled to the head member, wherein the bicycle handle is configured for rotating around a handle axis of the bicycle handle in relation to the head member, wherein the twist-lock mechanism comprises a first lock mechanism part and a second lock mechanism part, wherein the first lock mechanism part is disposed on the bicycle handle and the second lock mechanism part is disposed on the head member, wherein the rotating of the bicycle handle to at least one handle position in relation to the head member is configured for engaging the first lock mechanism part with the second lock mechanism part, wherein the engaging restricts subsequent rotating of the bicycle handle in relation to the head member from the at least one handle position.

7. The symmetric bicycle of claim 1, wherein the crank wheel comprises a plurality of protrusion disposed on a periphery of the crank wheel.

8. The symmetric bicycle of claim 1, wherein the first wheel portion comprises a first conical portion and the second wheel portion comprises a second conical portion, wherein the second conical portion is retractably insertable in the first conical portion and the first conical portion is retractably insertable in the second conical portion forming a wheel groove, wherein a second apex end of the second conical portion is retractably insertable in a first apex end of the first conical portion up to a second base end of the second conical portion and the first apex end is retractably insertable in the second apex end up to a first base end of the first conical portion, wherein the wheel groove comprises an inner periphery characterized by a peripheral circumference corresponding to a conical circumference of the each of the first conical portion and the second conical portion at a length from each of the first apex end the second apex end.

9. The symmetric bicycle of claim 8, wherein the conical circumference progressively increases along a length of each of the first conical portion and the second conical portion from each of the first apex end and the second apex end to each of the first base end and the second base end, wherein the peripheral circumference corresponding to the conical circumference progressively increases based on inserting of the second conical portion in the first conical portion along the length from the second apex end up to the second base end and inserting of the first conical portion in the second conical portion along the length from the first apex end up to the first base end.

10. The symmetric bicycle of claim 8, wherein the conical circumference progressively decreases along a length of each of the first conical portion and the second conical portion from each of the first base end and the second base end to each of the first apex end and the second apex end, wherein the peripheral circumference corresponding to the conical circumference progressively decreases based on retracting of the second conical portion from the first conical portion along the length from the second base end up to the second and end and retracting of the first conical portion from the second conical portion along the length from the first base end up to the first apex end.

11. The symmetric bicycle of claim 7 further comprising a retractable inserting mechanism coupled with the first conical portion and the second conical portion, wherein the retractable inserting mechanism comprises a spring-loaded piston configured for retractably inserting the second conical portion in the first conical portion and the first conical portion in the second conical portion.

12. The symmetric bicycle of claim 1 further comprising a lock assembly coupled with at least one of the top member and the seat member, wherein the lock assembly is configured for securing the symmetric bicycle to at least one object, wherein the lock assembly comprises an extendable cable and a knot disposed on a first end of the cable, wherein the knot catches a second end of the cable for the securing of the symmetric bicycle.

13. The symmetric bicycle of claim 1, wherein the bicycle frame configured for receiving at least one fluid, wherein the bicycle frame is configured for storing the at least one fluid, wherein at least one the seat member, the down member, the top member, and the head member comprises a cavity for the receiving and the storing of the at least one fluid, wherein the bicycle frame is configured for transferring the at least one fluid for inflating at least one tire associated with the plurality of bicycle wheels.

14. A symmetric bicycle comprising:
a bicycle frame comprising a seat member, a down member, a top member, and a head member, wherein a first top end of the top member and a first down end of the down member are coupled to the head member, wherein a second top end of the top member is coupled to the seat member proximal to a first seat end of the seat member, wherein a second down end of the down member is coupled to the seat member proximal to a second seat end of the seat member, wherein the seat member comprises a fork disposed on the second seat end, wherein the fork comprises at least one fork leg extending parallelly along a seat longitudinal axis of the seat member;
a bicycle handle coupled to the bicycle frame;
a plurality of bicycle wheels coupled to the bicycle frame, wherein the plurality of bicycle wheels comprises at least one front bicycle wheel and at least one rear bicycle wheel;
a crank assembly coupled with at least one of the at least one front bicycle wheel and the at least one rear bicycle wheel for propelling the symmetric bicycle, wherein the crank assembly comprises a crank wheel symmetrically disposed along a vertical plane passing through the seat member, wherein the crank wheel comprises a first wheel portion disposed on a first side of the vertical plane and a second wheel portion disposed on a second side of the vertical plane, wherein the crank wheel is rotatably coupled to a distal end of the at least one fork leg, wherein the crank wheel is rotatable around a crank wheel axis, wherein the crank wheel axis is perpendicular to the seat longitudinal axis, wherein the crank assembly comprises at least one pedal mechanism coupled to the crank wheel, wherein the at least one pedal mechanism is configured for receiving at least one force, wherein the receiving is configured for rotating the crank wheel in a rotating direction; and
a direction converter assembly disposed on the bicycle frame, wherein the rotating direction comprises a first rotating direction and a second rotating direction, wherein the crank wheel is coupled with at least one of the at least one front bicycle wheel and the at least one rear bicycle wheel using the direction converter assembly, wherein the direction converter assembly is configured for rotating at least one of the at least one front bicycle wheel and the at least one rear bicycle wheel in the first rotating direction corresponding to the rotating of the crank wheel in each of the first rotating direction and the second rotating direction.

15. The symmetric bicycle of claim 14, wherein the direction converter assembly comprises a converter housing, wherein the direction converter assembly comprises a first rod and a second rod, wherein the first rod and the second rod are parallelly disposed in the converter housing, wherein the first rod comprises a first wheel, a first gear and a first pulley, wherein the first wheel, the first gear and the first pulley is rotatable around the first rod, wherein the first gear and the first pulley is coupled with the first wheel, wherein the first wheel is coupled with at least one of the at least one front bicycle wheel and the at least one rear bicycle wheel, wherein the second rod comprises a second wheel a second gear and the second pulley, wherein the second wheel, the second gear and the second pulley is rotatable around the second rod, wherein the second gear is coupled with the second wheel, wherein the second wheel is coupled with the crank wheel, wherein the second gear is couplable to the first gear, wherein the second pulley is coupled with the first pulley, wherein the second wheel is couplable to the second pulley, wherein the second rod comprises a lever mechanism, wherein the crank wheel is configured for rotating the second wheel in the rotation direction, wherein the lever mechanism is configured coupling the second gear to the first gear based on the rotating of the second wheel in the second rotating direction, wherein the second gear is configured to rotate the first gear in the first rotating direction and the first wheel in the first rotating direction, wherein the lever mechanism is configured for coupling the second wheel to the second pulley based on the rotating of the second wheel in the first rotating direction, wherein the second pulley is configured for rotating the first pulley in the first rotating direction and the first wheel in the first rotating direction.

16. The symmetric bicycle of claim 14, wherein the plurality of bicycle wheels comprises a plurality of wheel hubs, wherein a rear wheel hub of the plurality of wheel hubs comprises a first hub, a second hub, and a hub wheel, wherein the first hub is axially coupled to a first side of the hub wheel and the second hub is axially coupled to a second side of the hub wheel, wherein the at least one rear wheel comprises a first rear bicycle wheel and a second rear bicycle wheel, wherein the first rear bicycle wheel is coupled to the first hub and the second rear bicycle wheel is coupled to the second hub, wherein the hub wheel is coupled with the crank wheel.

17. The symmetric bicycle of claim 14, wherein at least one of the at least one front bicycle wheel and the at least one rear bicycle wheel comprises an anti-rollback assembly, wherein the anti-rollback assembly comprises a brake disc disposed of on at least one of the at least one front bicycle wheel and the at least one rear bicycle wheel, wherein the anti-rollback assembly comprises a lever disposed on the bicycle frame, wherein the lever is engageably couplable with the brake disc, wherein the brake disc comprises a plurality of grooves disposed on the periphery of the brake disc, wherein the lever is configured for engaging with at least one groove of the plurality of grooves based on a change in rotation of at least one of the at least one front bicycle wheel and the at least one rear bicycle wheel form a first direction to a second direction, wherein the engaging restricts subsequent rotation of at least one of the at least one front bicycle wheel and the at least one rear bicycle wheel in the second direction.

18. The symmetric bicycle of claim 14, wherein the bicycle handle comprises a twist-lock mechanism, wherein the bicycle handle is rotatably coupled to the head member, wherein the bicycle handle is configured for rotating around a handle axis of the bicycle handle in relation to the head member, wherein the twist-lock mechanism comprises a first lock mechanism part and a second lock mechanism part, wherein the first lock mechanism part is disposed on the bicycle handle and the second lock mechanism part is disposed on the head member, wherein the rotating of the bicycle handle to at least one handle position in relation to the head member is configured for engaging the first lock mechanism part with the second lock mechanism part, wherein the engaging restricts subsequent rotating of the bicycle handle in relation to the head member from the at least one handle position.

19. The symmetric bicycle of claim 14, wherein the first wheel portion comprises a first conical portion and the second wheel portion comprises a second conical portion, wherein the second conical portion is retractably insertable in the first conical portion and the first conical portion is retractably insertable in the second conical portion forming a wheel groove, wherein a second apex end of the second conical portion is retractably insertable in a first apex end of the first conical portion up to a second base end of the second conical portion and the first apex end is retractably insertable in the second apex end up to a first base end of the first conical portion, wherein the wheel groove comprises an inner periphery characterized by a peripheral circumference corresponding to a conical circumference of the each of the first conical portion and the second conical portion at a length from each of the first apex end the second apex end.

20. The symmetric bicycle of claim 19 further comprising a retractable inserting mechanism coupled with the first conical portion and the second conical portion, wherein the retractable inserting mechanism comprises a spring-loaded piston configured for retractably inserting the second conical portion in the first conical portion and the first conical portion in the second conical portion.
